(19) United States
(12) Patent Application Publication
(10) Pub. No.: US 2015/0034709 A1
(43) Pub. Date: Feb. 5, 2015

(54) CARTON WITH INSERT

(71) Applicant: Graphic Packaging International, Inc., Atlanta, GA (US)

(72) Inventors: Raymond R. Spivey, SR., Mableton, GA (US); Colin P. Ford, Woodstock, GA (US)

(21) Appl. No.: 14/449,576

(22) Filed: Aug. 1, 2014

Related U.S. Application Data
(60) Provisional application No. 61/958,652, filed on Aug. 2, 2013.
(60) Provisional application No. 61/959,539, filed on Aug. 26, 2013.
(60) Provisional application No. 61/965,693, filed on Feb. 5, 2014.

(51) Int. Cl. B65D 5/46; B31B 1/00; B65D 5/50; B65D 5/42; B65D 5/49

(52) U.S. Cl. CPC B65D 5/46192; B65D 5/4204; B65D 5/48024; B65D 5/5028; B31B 1/00
USPC 229/117.24; 229/120.38; 229/162.1; 493/309

(57) ABSTRACT

A carton for holding a plurality of containers. The carton comprises a plurality of panels that extends at least partially around an interior of the carton. The plurality of panels can comprise a top panel, an outer side panel, and a bottom panel. An insert can comprise a central panel, an inner side panel foldably connected to the central panel, and a bottom flap foldably connected to the inner side panel. The inner side panel is spaced apart from the outer side panel, and at least a portion of the bottom flap extends from the inner side panel to the outer side panel.

### CROSS-REFERENCE TO RELATED APPLICATIONS

This application claims the benefit of U.S. Provisional Patent Application No. 61/958,652, filed Aug. 2, 2013, U.S. Provisional Patent Application No. 61/959,539, filed Aug. 26, 2013, and U.S. Provisional Patent Application No. 61/965,693, filed Feb. 5, 2014.

### INCORPORATION BY REFERENCE

The disclosures of U.S. Provisional Patent Application No. 61/958,652, which was filed on Aug. 2, 2013, U.S. Provisional Patent Application No. 61/959,539, which was filed on Aug. 26, 2013, and U.S. Provisional Patent Application No. 61/965,693, which was filed on Feb. 5, 2014, are hereby incorporated by reference for all purposes as if presented herein in their entirety.

### BACKGROUND OF THE DISCLOSURE

The present disclosure generally relates to cartons for holding beverage containers or other types of articles. More specifically, the present disclosure relates to cartons having an insert.

### SUMMARY OF THE DISCLOSURE

In general, one aspect of the disclosure is directed to a carton for holding a plurality of containers. The carton comprises a plurality of panels that extends at least partially around an interior of the carton. The plurality of panels can comprise a top panel, an outer side panel, and a bottom panel. An insert can comprise a central panel, an inner side panel foldably connected to the central panel, and a bottom flap foldably connected to the inner side panel. The inner side panel is spaced apart from the outer side panel, and at least a portion of the bottom flap extends from the inner side panel to the outer side panel.

In another aspect, the disclosure is generally directed to, in combination, a carton blank and an insert blank for forming a carton and an insert at least partially disposed in the carton for holding a plurality of containers. The carton blank can comprise a plurality of panels comprising a top panel, an outer side panel, and a bottom panel. The insert blank can comprise a central panel, an inner side panel foldably connected to the central panel, and a bottom flap foldably connected to the inner side panel. The inner side panel is for being spaced apart from the outer side panel and at least a portion of the bottom flap is for extending from the inner side panel to the outer side panel when the carton and the insert are formed from the carton blank and the insert blank.

In another aspect, the disclosure is generally directed to a method of forming a carton for holding a plurality of containers. The method can comprise obtaining a carton blank and an insert blank. The carton blank can comprise a plurality of panels comprising a top panel, an outer side panel, and a bottom panel. The insert blank can comprise a central panel, an inner side panel foldably connected to the central panel, and a bottom flap foldably connected to the inner side panel. The method further can comprise forming an interior of the carton at least partially defined by the plurality of panels of the carton blank. The forming the interior of the carton can comprise forming an open-ended sleeve. The method also can comprise forming an insert from the insert blank, and positioning the insert at least partially in the interior of the carton so that the inner side panel is spaced apart from the outer side panel and at least a portion of the bottom flap extends from the inner side panel to the outer side panel.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a carton blank used to form a carton according to a first exemplary embodiment of the disclosure.

FIG. 2 is a plan view of an insert blank for forming an insert according to the first exemplary embodiment of the disclosure.

FIGS. 3-5 are perspective views of a partially-erected carton formed from the carton blank of FIG. 1 according to the first exemplary embodiment of the disclosure.

FIG. 6 is a perspective view showing the formation of the insert from the insert blank of FIG. 2 according to the first exemplary embodiment of the disclosure.

FIGS. 7A-7D are perspective views of the insert according to the first exemplary embodiment of the disclosure.

FIGS. 8A and 8B are perspective views showing the loading the insert of FIGS. 7A-7D into the partially-erected carton according to the first exemplary embodiment of the disclosure.

FIG. 8C is a perspective view of the partially-erected carton showing the closing of an end of the carton.

FIGS. 9A and 9B are perspective views of the erected carton according to the first exemplary embodiment of the disclosure.

FIG. 9C is a partial side view of the carton of FIGS. 9A and 9B.

FIGS. 10-12 are views showing the opening and closing of a dispenser of the carton of FIGS. 9A and 9B according to the first exemplary embodiment of the disclosure.

FIG. 13 is a plan view of an insert blank used to form an insert according to a second exemplary embodiment of the disclosure.

FIGS. 14 and 15 are perspective views of the insert formed from the insert blank of FIG. 13 according to the second exemplary embodiment of the disclosure.

FIG. 16 is a perspective view of a carton with the insert of FIGS. 14 and 15 according to the second exemplary embodiment of the disclosure.

FIG. 17 is a plan view of an insert blank for forming an insert according to a third exemplary embodiment of the disclosure.

FIG. 18 is a plan view of blank for forming a carton according to a fourth exemplary embodiment of the disclosure.

FIG. 19 is a plan view of a carton blank used to form a carton according to a fifth exemplary embodiment of the disclosure.

FIG. 20 is a plan view of an insert blank for forming an insert according to the fifth exemplary embodiment of the disclosure.

FIG. 21 is a perspective view of the erected carton according to the fifth exemplary embodiment of the disclosure.

FIGS. 22 and 23 are perspective views of the carton of FIG. 21 with an actuated dispenser according to the fifth exemplary embodiment of the disclosure.

FIG. 24 is a plan view of an insert blank for forming an insert according to a sixth exemplary embodiment of the disclosure,

FIG. 25 is a plan view of an insert blank for forming an insert according to a seventh exemplary embodiment of the disclosure.

FIG. 26 is a perspective view showing the formation of the insert from the insert blank of FIG. 25 according to the seventh exemplary embodiment of the disclosure.

FIG. 27 is a perspective view of the insert according to the seventh exemplary embodiment of the disclosure.

FIGS. 28 and 29 are perspective views showing the loading the insert of FIG. 27 into a partially-erected carton according to the seventh exemplary embodiment of the disclosure.

FIG. 30 is a plan view of an insert blank for forming an insert according to an eighth exemplary embodiment of the disclosure.

FIGS. 31 and 32 are perspective views showing the formation of the insert from the insert blank of FIG. 30 according to the eighth exemplary embodiment of the disclosure.

FIGS. 33 and 34 are perspective views of a retaining feature of the insert according to the eighth exemplary embodiment of the disclosure.

FIGS. 35 and 36 are perspective views showing the loading the insert of FIGS. 33 and 34 into the partially-erected carton according to the eighth exemplary embodiment of the disclosure.

FIG. 37 is a plan view of an insert blank for forming an insert according to a ninth exemplary embodiment of the disclosure.

FIG. 38 is a plan view of an insert blank for forming an insert according to a tenth exemplary embodiment of the disclosure.

FIGS. 39 and 40 are perspective views showing the formation of the insert and the retention features from the insert blank of FIG. 38 according to the tenth exemplary embodiment of the disclosure.

Corresponding parts are designated by corresponding reference numbers throughout the drawings.

### DETAILED DESCRIPTION OF THE EXEMPLARY EMBODIMENTS

The present disclosure generally relates to cartons that contain articles such as containers, bottles, cans, etc. The articles can be used for packaging food and beverage products, for example. The articles can be made from materials suitable in composition for packaging the particular food or beverage item, and the materials include, but are not limited to, aluminum and/or other metals; glass; aseptic bricks; paperboard; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes beverage containers (e.g., aseptic packages, such as, but not limited to, Tetra Brik® by Tetra Pak International S.A.) as disposed within the carton embodiments. In this specification, the terms “inner,” “interior,” “outer,” “exterior,” “lower,” “bottom,” “upper,” and “top” indicate orientations determined in relation to fully erected and upright cartons.

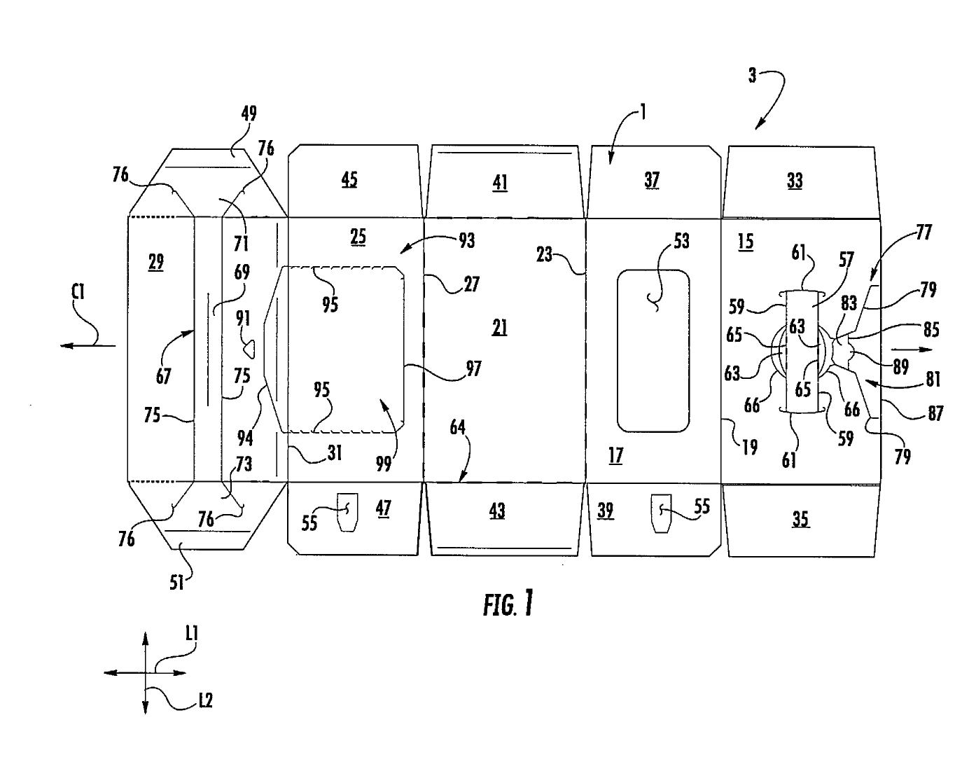

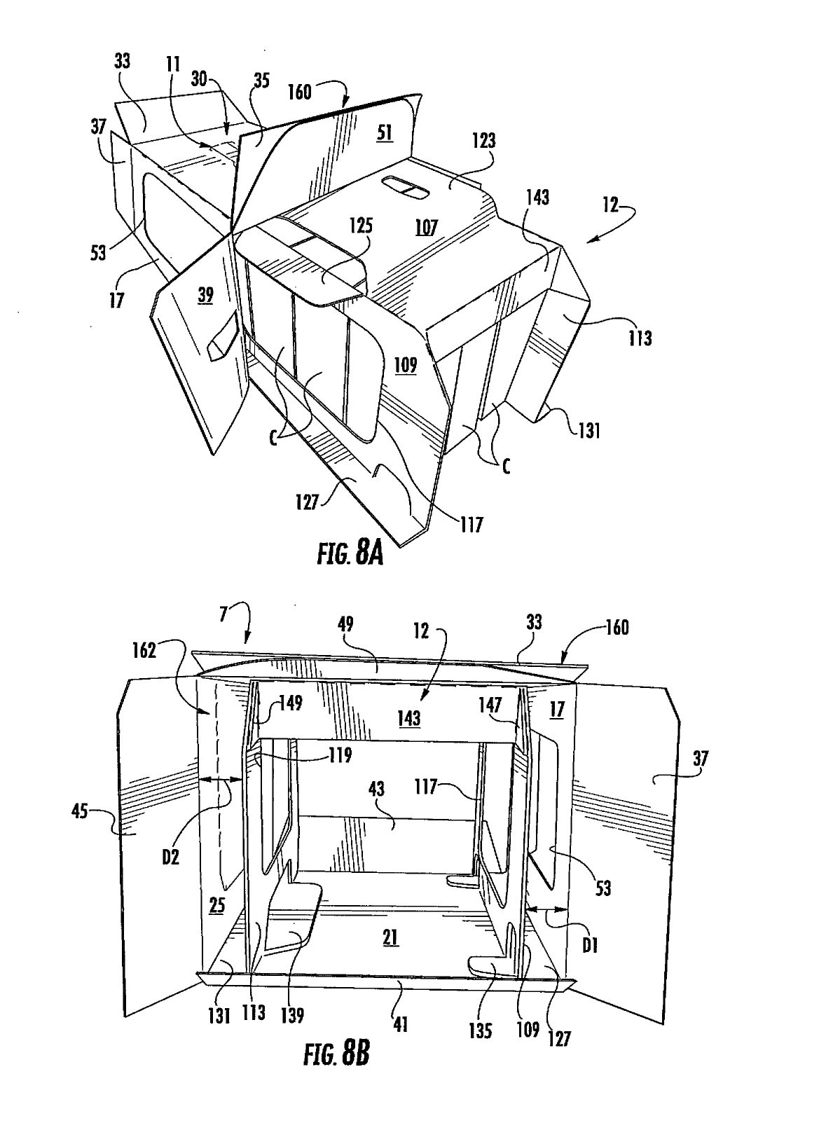

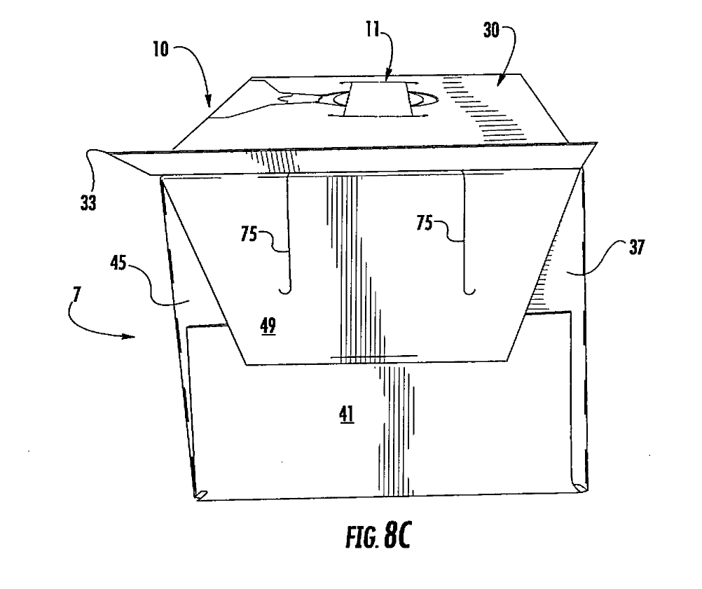

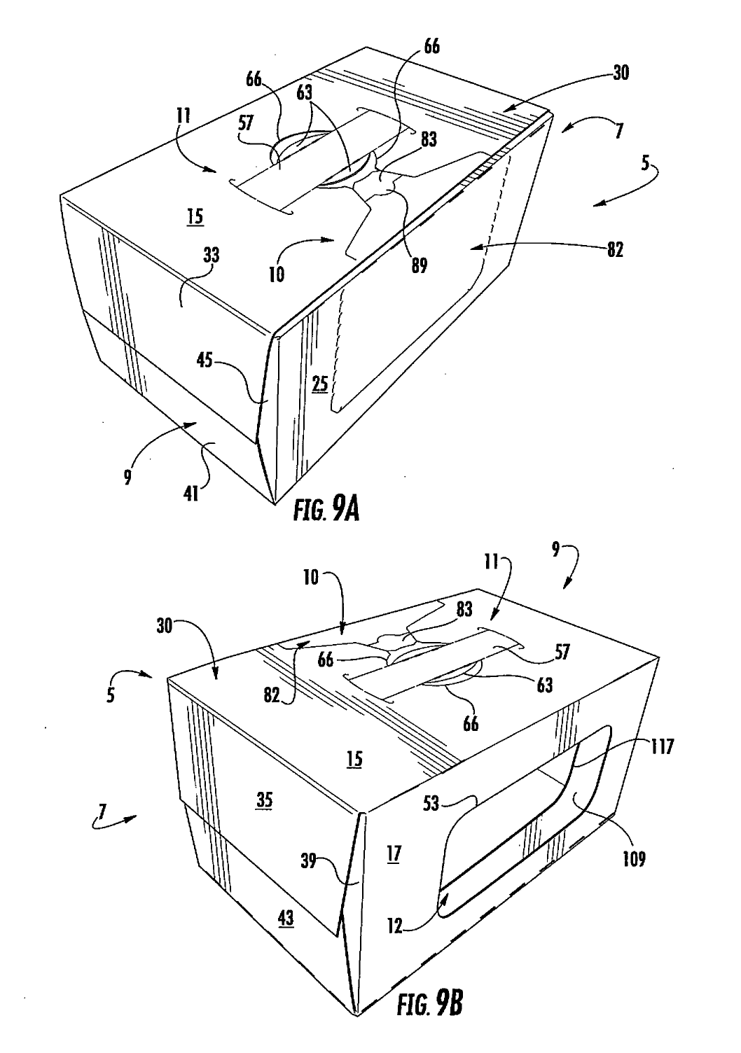

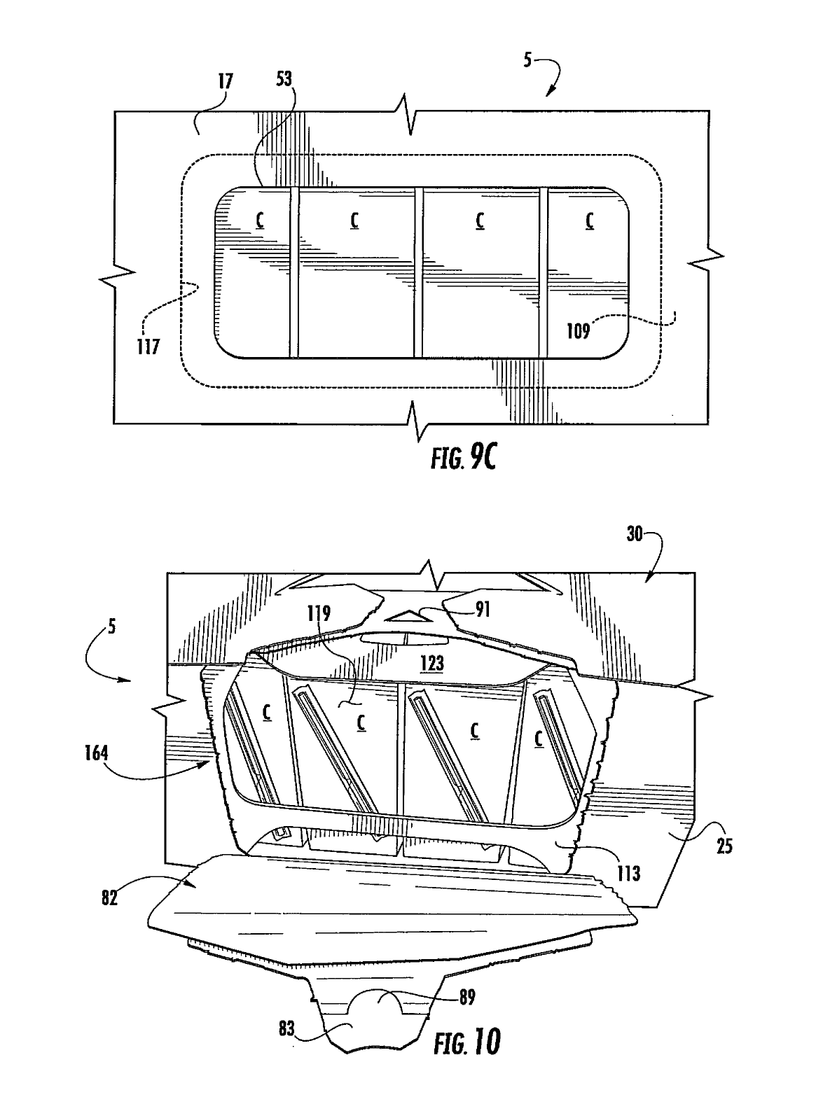

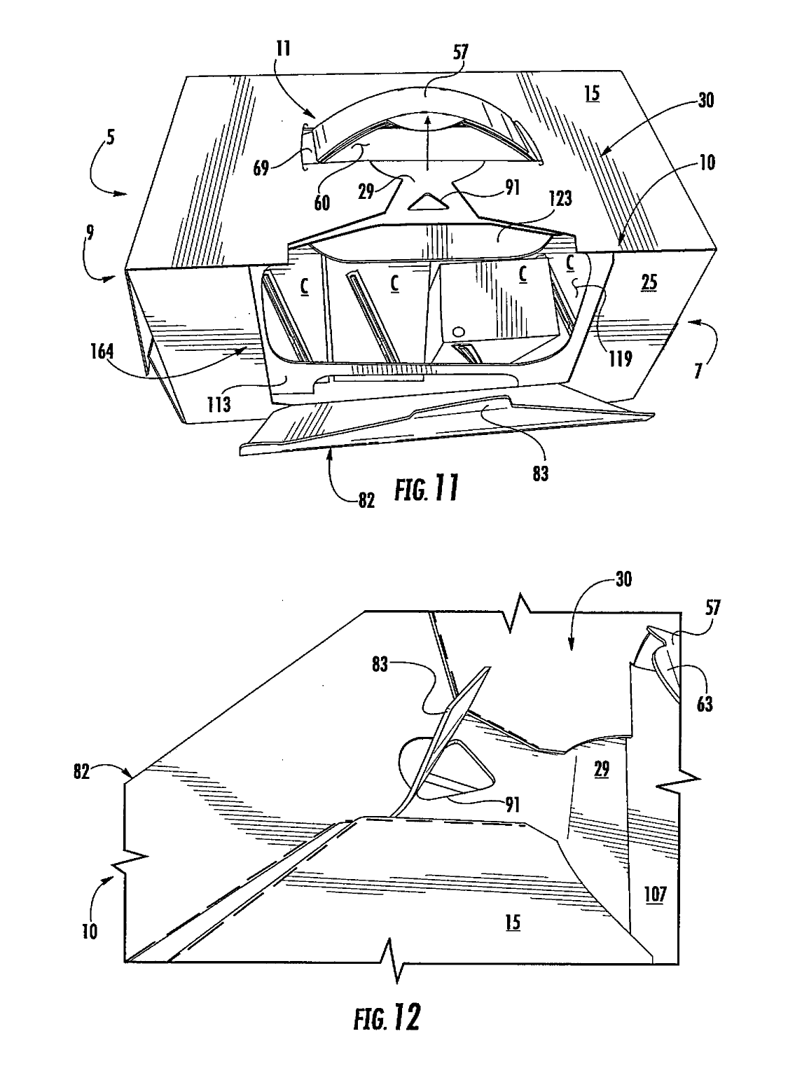

FIG. 1 is a plan view of the exterior side 1 of a carton blank, generally indicated at 3, used to form a carton 5 (FIGS. 9A and 9B) according to the first exemplary embodiment of the disclosure. The carton 5 can be used to house a plurality of articles such as containers C (FIGS. 6A-8A, 9C, 10 and 11). In one embodiment, the containers C can be generally brick-shaped (e.g., parallelepipedal) and can be any suitable size. Alternatively, the articles could be any suitable shape and/or size. In the illustrated embodiment, the carton 5 is sized to house twelve containers C in a single layer in a 3×4 arrangement, but it is understood that the carton 5 may be sized and shaped to hold containers of a different or same quantity in more than one layer and/or in different row/column arrangements (e.g., 1×6, 3×6, 2×6×2, 3×5, 4×5, 2×9, 2×6, 4×4, etc.). The carton 5 can include a dispenser 10 (FIGS. 9A and 10-12) for allowing access to the containers C. In the illustrated embodiment, the carton 5 includes a handle 11 (FIGS. 8C, 9A, 9B, and 11) extending in a top of the carton and into a first end 7 and a second end 9 of the carton for grasping and carrying the carton. As will be discussed below in more detail, the handle 11, is formed from various features in the blank 3. In the illustrated embodiment, the carton 5 includes a spacer insert 12 (FIGS. 6-8B) that reinforces and stabilizes the containers C in the carton and that can help retain the containers C in a central portion of the interior of the carton, spaced apart from the sides and/or ends of the carton.

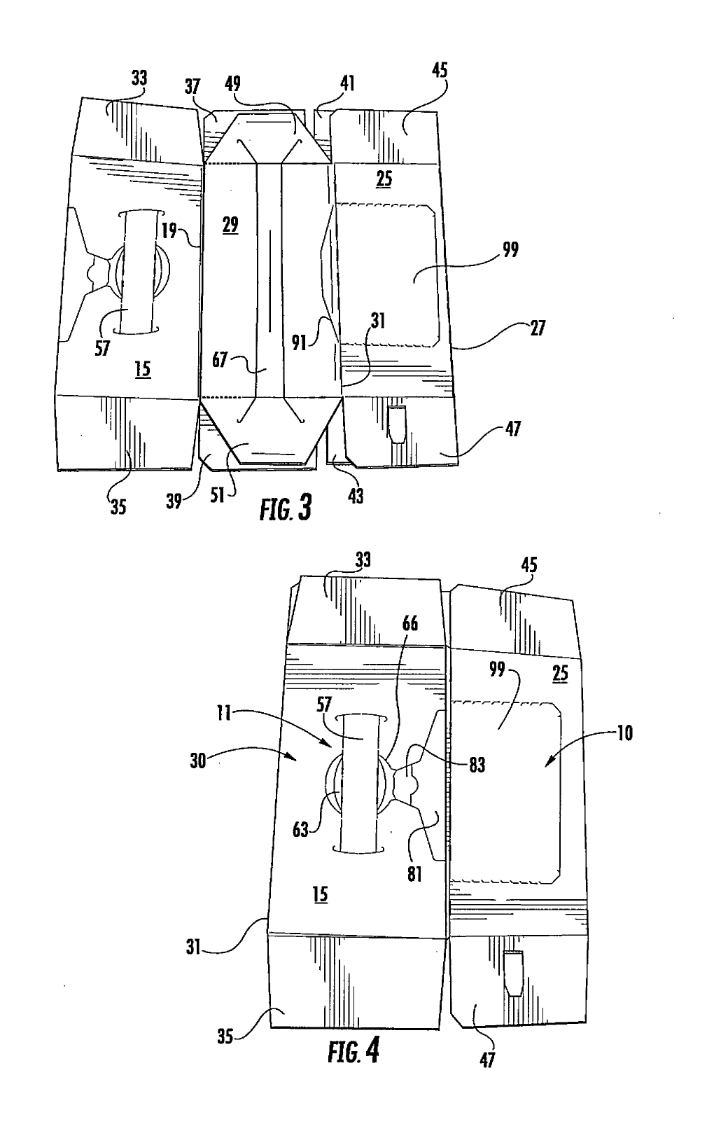

The carton blank 3 has a longitudinal axis L1 and a lateral axis L2. The carton blank 3 can include a longitudinal centerline C1, as shown in FIG. 1. In the illustrated embodiment, the blank 3 comprises a first top panel 15 (e.g., outer top panel) foldably connected to a first side panel 17 (e.g., front panel) at a first lateral fold line 19. A bottom panel 21 is foldably connected to the first side panel 17 at a second lateral fold line 23. A second side panel 25 (e.g., rear or back panel) is foldably connected to the bottom panel 21 at a third lateral fold line 27. A second top panel 29 (e.g., inner top panel) is foldably connected to the second side panel 25 at a fourth lateral fold line 31. The first and second top panels 15, 29 can at least partially overlap in the erected carton 5 to farm a top wall 30 (FIGS. 4, 5, 9A, 9B, and 11). Any of the top and bottom panels 15, 29, 21 and the first and second side panels 17, 25 can be otherwise shaped, arranged, configured, or omitted, without departing from the disclosure. For example, the blank 3 can alternatively include one top panel and an attachment flap cooperating to form a top of the carton 5 or two bottom panels cooperating to form a bottom of the carton.

The first top panel 15 is foldably connected to a first top end flap 33 and a second top end flap 35. The first side panel 17 is foldably connected to a first side end flap 37 and a second side end flap 39. The bottom panel 21 is foldably connected to a first bottom end flap 41 and a second bottom end flap 43. The second side panel 25 is foldably connected to a first side end flap 45 and a second side end flap 47. The second top panel 29 is foldably connected to a first top end flap 49 and a second top end flap 51. When the carton 5 is erected, the top and bottom end flaps 33, 49, 41 and side end flaps 37, 45 close the first end 7 of the carton, and the top and bottom end flaps 35, 51, 43 and side end flaps 39, 47 close the second end 9 of the carton. In accordance with an alternative embodiment of the present disclosure, different flap arrangements can be used for at least partially closing the ends 7, 9 of the carton 5.

In one embodiment, the top and bottom end flaps 33, 49, 41 and side end flaps 37, 45 extend along a first marginal area of the blank 3 and are foldably connected at a first longitudinal fold line 62 that extends along the length of the blank. In the illustrated embodiment, the top and bottom end flaps 35, 51, 43 and side end flaps 39, 47 extend along a second marginal area of the blank 3 and are foldably connected at a second longitudinal fold line 64 that also extends along the length of the blank. The longitudinal fold lines 62, 64 may be, for example, substantially straight, or offset at one or more locations to account for blank thickness or for other factors. In one embodiment, the respective portions of the longitudinal fold lines 62, 64 connecting the respective top end flaps 33, 35 to the first top panel 15 can include multiple fold lines (as shown in FIG. 1), thickened fold lines, and/or folding areas, for example. The longitudinal fold lines 62, 64 could be otherwise shaped, arranged, and/or configured without departing from the disclosure.

As shown in FIG. 1, the first side panel 17 can include an opening or window 53 for displaying the containers C in the interior of the carton 5. In an alternative embodiment, the window 53 could be at least partially covered (e.g., by a transparent or translucent plastic sheet). The carton blank 3 can also include one or more pull-up holes 55. As shown in FIG. 1, the pull-up holes 55 are disposed in the side end flap 39, 47 and can help the carton-forming tools maneuver and manipulate the carton blank 3. The window 53 and/or the pull-up holes 55 could be omitted or could be otherwise shaped, arranged, and/or configured without departing from the disclosure.

The features that comprise the handle 11 can include a first (e.g., outer) handle panel 57 in the first top panel 15. The first handle panel 57 can be separable from the remainder of the first top panel 15 along lateral cut or tear lines 59 (e.g., lines of weakening) and end cut or tear lines 61 (e.g., lines of weakening). In one embodiment, the tear lines 59, 61 can include one or more nicks to help retain the first handle panel 57 in the first top panel 15 until the handle 11 is activated. The end tear lines 61 can include hook-shaped cuts at the ends thereof to help prevent unwanted tearing of the first top panel 15. In the illustrated embodiment, the first handle panel 57 includes two handle flaps 63 foldably connected to the first handle panel at respective lateral fold lines 65. In one embodiment, an access opening 66 can be formed on either side of the first handle panel 57 adjacent the handle flaps 65.

The handle features also can include a second (e.g., inner) handle panel 67 in the second top panel 29 and the top end flaps 49, 51. The second handle panel 67 can include a central portion 69 in the second top panel 29 and end portions 71, 73 in the respective top end flaps 49, 51. The second handle panel 67 can be detachably connected to the second top panel 29 and top end flaps 49, 51 along tear or cut lines 75 (e.g., lines of weakening) that extend from the second top panel 29 into respective end flaps 49, 51. As shown in FIG. 1, the cut lines 75 can extend in the lateral L2 direction in the second top panel 29 and can be oblique in the top end flaps 49, 51 so that the second handle panel 67 widens in the top end flaps. In the illustrated embodiment, hook-shaped cuts 76 can be formed in the top end flaps 49, 51 at the ends of the cut lines 75 to help prevent unwanted tearing of the top end flaps when the carton 5 is carried at the handle 11. The handle features, including the first handle panel 57 and/or the second handle panel 67, could be omitted or could be otherwise shaped, arranged, and/or configured without departing from the disclosure.

According to the illustrated embodiment, the dispenser 10 includes a first dispenser pattern 77 in the first top panel 15. The first dispenser pattern 77 includes tear or cut lines 79 that form a first portion 81 of a dispenser panel 82 (FIGS. 4, 5, 9A, and 10B). The dispenser pattern 77 can also include an access feature such as the access flap 83 that is foldably connected to the first dispenser portion 81 along fold lines 85. The access flap 83 can be adjacent one of the handle openings 66 as shown in FIG. 1. The cut lines 79 can extend from proximate a free edge 87 of the first top panel 15 to the adjacent handle opening 66. The access flap 83 can help initiate tearing along the cut lines 79 by pulling upwardly on the access flap at the adjacent handle opening 66 and folding the access flap along the fold lines 85. Additionally, the access flap 83 can include a locking tab 89 that can cooperate with (e.g. engage) a receiving opening 91 in the second top panel 29 for helping to reclose the dispenser 10 after opening the carton 5. The locking tab 89 can be separable from the first dispenser portion 81 along a cut or tear line, as shown in FIG. 1. The first dispenser pattern 77 could be omitted or could be otherwise shaped, arranged, and/or configured without departing from the disclosure.

As shown in FIG. 1, the dispenser features further include a second dispenser pattern 93 in the second top panel 29 and the second side panel 25. The second dispenser pattern 93 includes a tear or cut line 94, tear lines 95, and a fold line 97 that form a second portion 99 of the dispenser panel 82. The second dispenser pattern 93 could be omitted or could be otherwise shaped, arranged, and/or configured without departing from the disclosure.

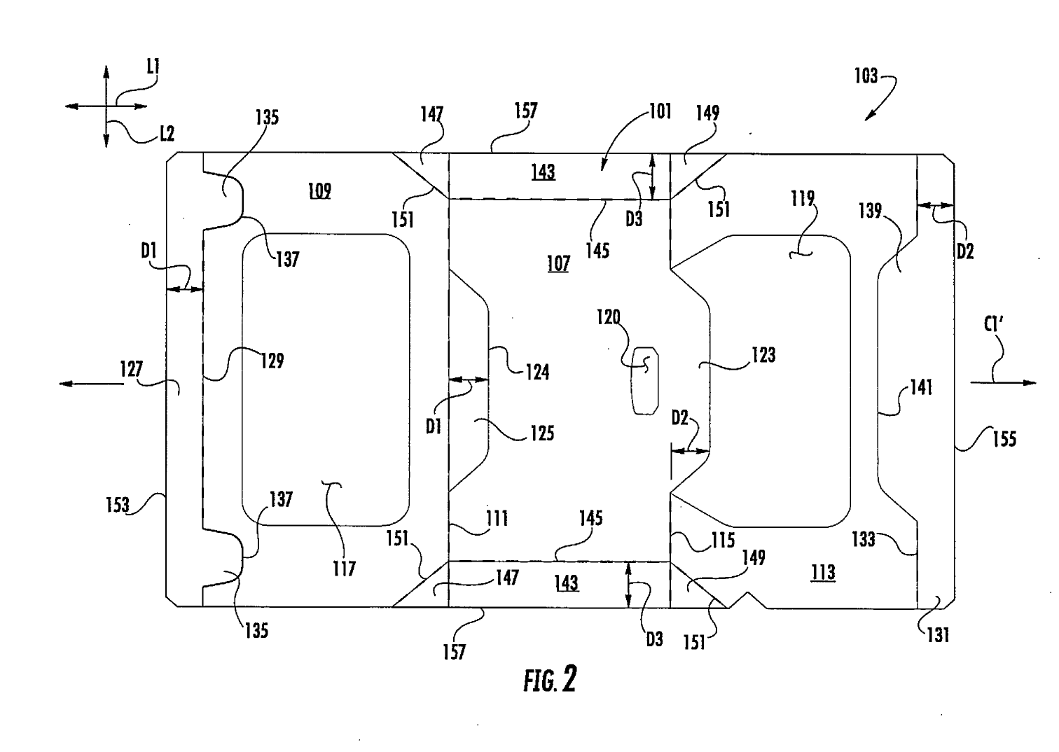

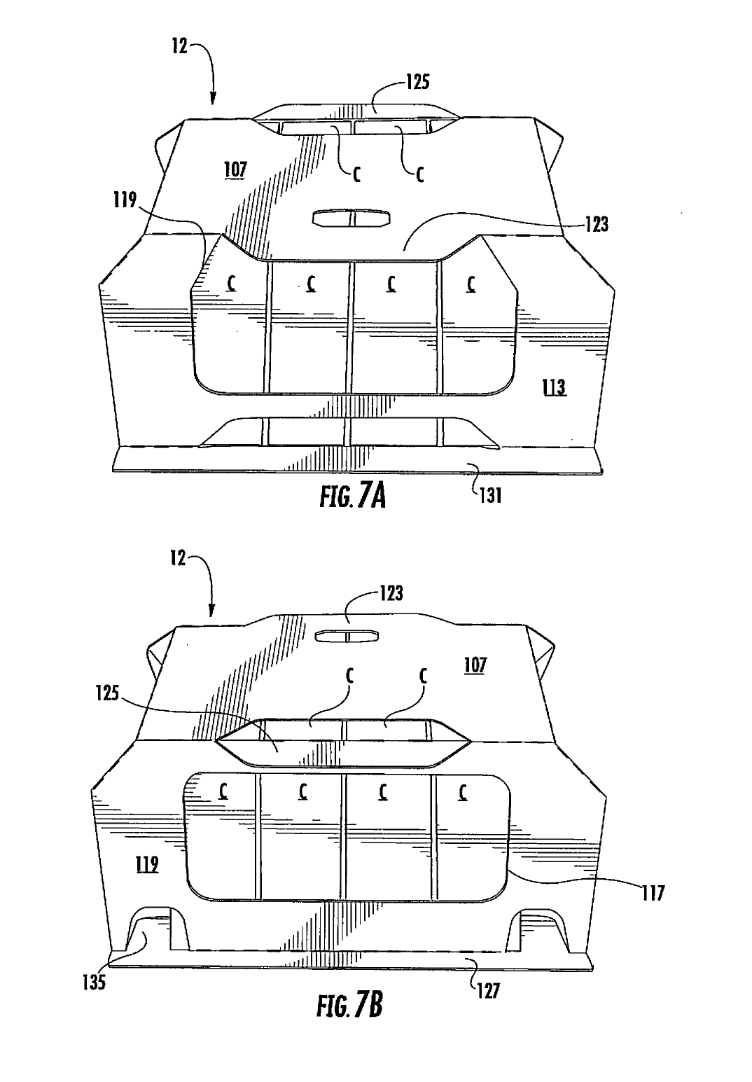

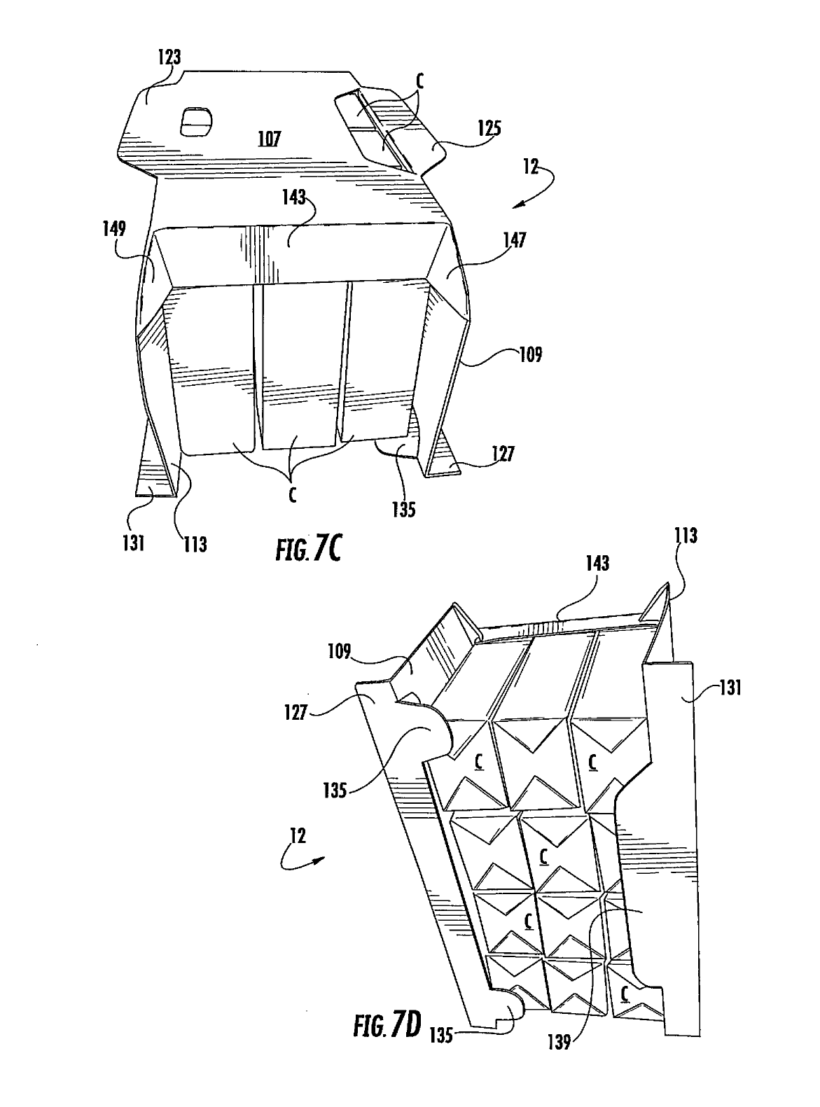

FIG. 2 illustrates an interior surface 101 of an insert blank 103 used to form the spacer insert 12 (FIGS. 7A-8B) for use in the carton 5 according to the exemplary embodiment of the disclosure. In one embodiment, the insert blank 103 could comprise corrugated cardboard such as E-flute cardboard. Alternatively, the insert blank 103 could be any suitable material (e.g., other corrugated cardboards, paperboard, and/or other materials).

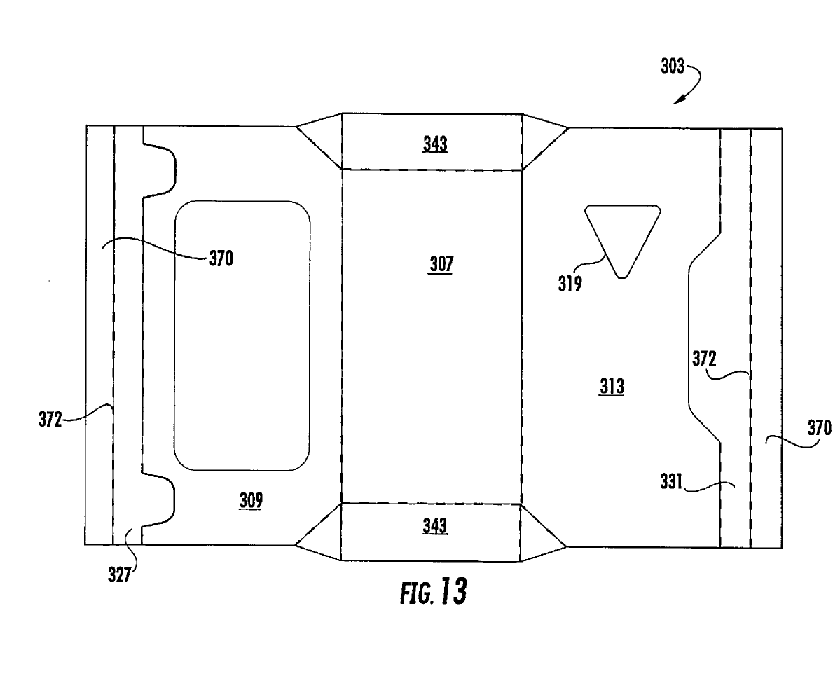

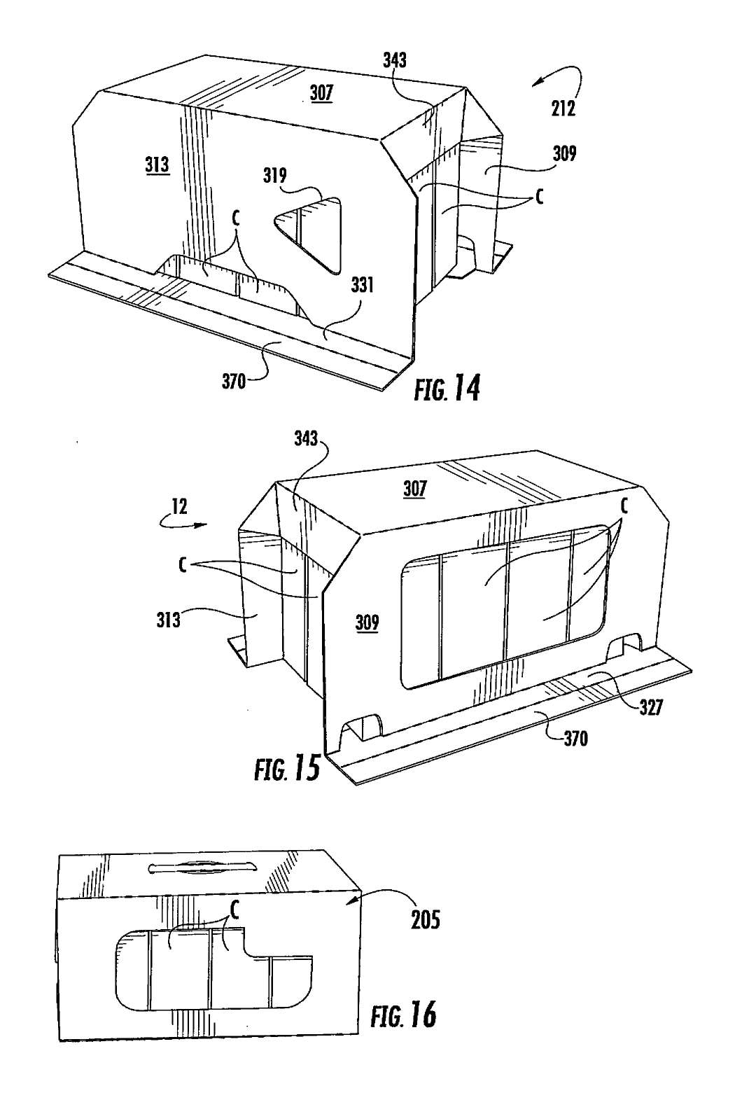

As shown in FIG. 2, the insert blank 103 has a longitudinal axis L1 and a lateral axis L2. The insert blank 103 can include a longitudinal centerline C1′ as shown in FIG. 2. In the illustrated embodiment, the insert blank 103 includes a central panel 107, a first inner side panel 109 (e.g., inner front panel) foldably connected to the central panel 107 along a lateral fold line 111, and a second inner side panel 113 (e.g., inner rear or back panel) foldably connected to the central panel 107 along a lateral fold line 115. In the illustrated embodiment, the first inner side panel 109 can include an opening or window 117 that can be aligned with the window 53 in the first side panel 17. In one embodiment, the window 117 is generally larger than the window 53 so that the containers C in the carton 5 are readily visible through the windows 53, 117 and the first inner side panel 109 is not readily visible through the window 53 from the exterior of the carton 5. In one embodiment, the dispenser 10 can include a dispenser opening 119 in the second inner side panel 113 and an opening 120 in the central panel 107. The dispenser opening 119 can be generally aligned with the dispenser panel 82 in the carton 5 so that the containers C can be removed through the carton 5 through the dispenser opening 119 and the dispenser opening 164 formed from the opened dispenser panel 82 (FIGS. 10 and 11). The opening 120 can be generally aligned with the opening 91 in the second top panel 29 for providing clearance for the locking tab 89 when the dispenser 10 is reclosed after an initial opening (FIG. 12). As shown in FIG. 2, the lateral fold line 115 can be interrupted by the dispenser opening 119 and a spacer projection or tab 123 can extend from the central panel 107 adjacent the dispenser opening 119. In one embodiment, a spacer flap 125 can be foldably connected to the first inner side panel 109 along the lateral fold line 111 and can be separable from the top panel along a fold or cut line 124.

In the illustrated embodiment, a first end or bottom flap 127 is foldably connected to the first inner side panel 109 along a first fold line 129, and a second end or bottom flap 131 is foldably connected to the second inner side panel 113 along a lateral fold line 133. As shown in FIG. 2, two bottom tabs 135 extend from the first bottom flap 127, interrupting the lateral fold line 129, and are separable from the first inner side panel 109 along respective tear or cut lines 137. A bottom tab 139 can extend from the second bottom flap 131, interrupting the lateral fold line 133, and can be separable from the second inner side panel 113 along a tear or cut line 141. As shown in FIG. 2, the bottom tabs 135, 139 extend from, and are continuous with, the respective bottom flaps 127, 131. Accordingly, while the bottom tabs 135, 139 extend from the respective bottom flaps 127, 131, the bottom tabs 135, 139 generally are considered to be portions of the respective bottom flaps 127, 131. In one embodiment, the bottom tab 139 can be an extended bottom tab that is generally centered on the longitudinal centerline of the insert blank 103 and is generally longer than the bottom tabs 135. Alternatively, the bottom tab 139 could be similar to the bottom tabs 135. In an alternative embodiment, the insert blank 103 can include any suitable number of bottom tabs 135, 139.

As shown in FIG. 2, the insert blank 103 can include two end panels 143 that are foldably connected to the central panel 107 along respective longitudinal fold lines 145. In the illustrated embodiment, gusset panels 147 connect the respective end panels 143 to the first inner side panel 109 and gusset panels 149 connect the respective end panels 143 to the second inner side panel 113. The end panels 143 are foldably connected to the gusset panels 147, 149 along the respective lateral fold lines 111, 115, and the gusset panels 147, 149 are foldably connected to the respective inner side panels 109, 113 along respective oblique fold lines 151. The insert blank 103 could be omitted or could be otherwise shaped, arranged, and/or configured without departing from the disclosure. For example, the spacer flap 125 could be replaced by a spacer projection, which could be a mirror image of the spacer projection 123. In another alternative embodiment, each of the gusset panels 147 and/or 149 could be replaced by multiple foldably-connected gusset panels.

In one embodiment, the spacer flap 125 can extend a distance D1 at its widest extent from the lateral fold line 111. The width of the first bottom flap 127 can have a width from the lateral fold line 129 to the laterally-extending edge 153 of the insert blank 103 that is generally the same as the distance D1. Accordingly, the first inner side panel 109 generally can be spaced apart from the first outer side panel 17 by the distance D1 (FIG. 8B). Similarly, the spacer projection 123 can extend a distance D2 into the dispenser opening 119 from the lateral fold line 115, and the width of the second bottom flap 131 can have a width from the lateral fold line 133 to the laterally-extending edge 155 of the insert blank 103 that is generally the same as the distance D2. Accordingly, the second inner side panel 113 generally can be spaced apart from the second outer side panel 25 by the distance D2 (FIG. 8B). In one embodiment, the distance D1 can be generally equal to the distance D2. As shown in FIG. 2, the end panels 143 can have respective widths D3 from the respective longitudinal fold lines 145 to the respective longitudinally-extending edges 157 of the blank 103. Accordingly, the end panels 143 can be spaced apart from the respective end edges of the inner side panels 109, 113 by the distance D3. In one embodiment, the end edges of the inner side panels 109, 113 can be disposed generally adjacent or in abutting relationship with the respective ends 7, 9 of the carton 5 when the carton and insert are assembled so that the end panels 143 of the insert 12 generally are spaced apart from the respective ends 7, 9 of the carton 5 by the distance D3. The spacer flap 125, the spacer projection 123, and/or the bottom end flaps 127, 131 could be otherwise shaped, arranged, and/or configured without departing from the disclosure. For example, the spacer flap 125 and the first bottom flap 127 could have different widths, the spacer projection 123 and the second bottom flap 131 could have different widths, and/or the end panels 143 could have different widths. Additionally, in an alternative embodiment, the spacer projection 123 could be replaced by a second spacer flap 125 foldably connected to the central panel 107 and/or the second inner side panel 113, or the spacer flap 125 could be replaced by a second spacer projection 123 extending from the central panel 107 and/or the first inner side panel 109.

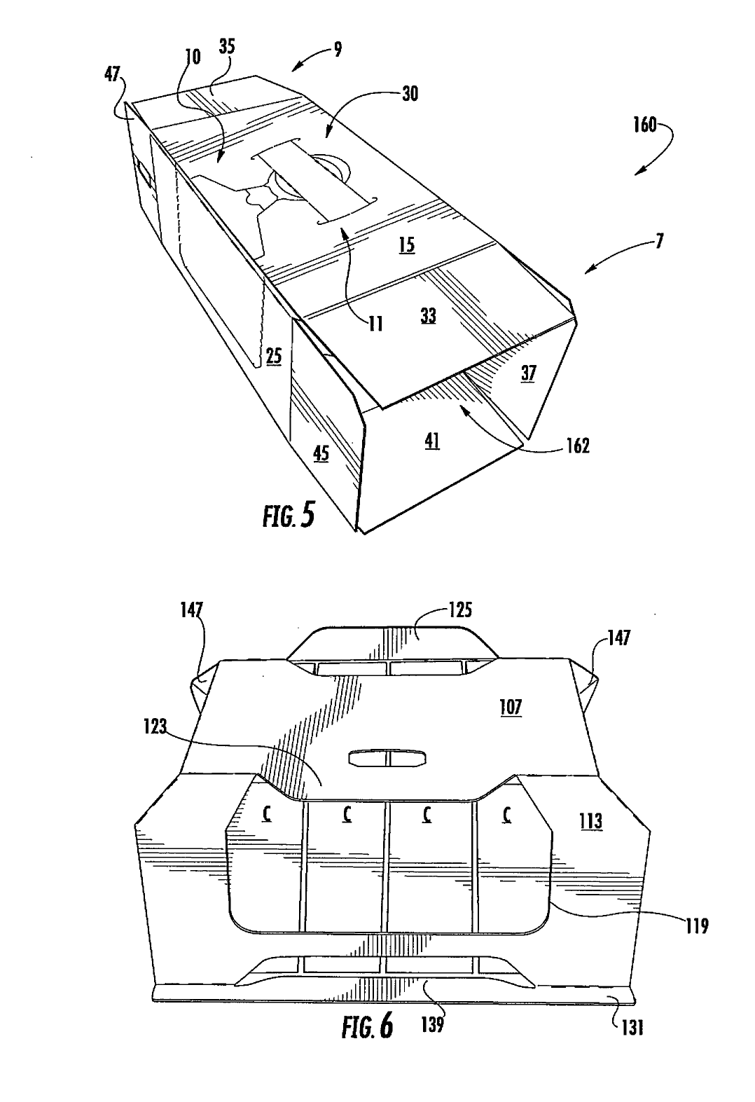

As shown in FIGS. 3-8C, in one exemplary embodiment, the carton 5 and insert 12 can be assembled from the carton blank 3 and the insert blank 103. As shown in FIGS. 3 and 4, the carton blank 3 can be folded along the lateral fold lines (e.g., along lateral fold lines 23, 31) so that the first top panel 15 at least partially overlaps the second top panel 29 and the top end flaps 33, 35 at least partially overlap the respective top end flaps 49, 51. In one embodiment, the exterior surfaces of the second top panel 29 and the top end flaps 49, 51 can be glued to the interior surfaces of the first top panel 15 and the top end flaps 33, 35, such as by glue strips. Additionally, the second handle panel 67 can be glued to the first handle panel 57, and the portion of the second dispenser portion 99 in the second top panel 29 can be glued to the first dispenser portion 81. Accordingly, the top panels 15, 29 can form the top wall 30, and the dispenser portions 81, 99 can form the dispenser panel 82. As shown in FIG. 5, the carton blank 103 can be folded along the lateral fold lines 19, 23, 27, 31 to form an open-ended sleeve 160 with an interior 162. The sleeve 160 could be otherwise formed without departing from the disclosure.

As shown in FIG. 6, the insert 12 can be formed, in one exemplary embodiment, by placing the insert blank 103 over the containers C in the 3×4 arrangement. The central panel 107 can be disposed on top of the containers C and the inner side panels 109, 113 can be downwardly folded as shown in FIG. 6. Alternatively, the tops of the containers C could be positioned on top of the center panel 107, and the inner side panels 109, 113 could be folded upwardly to extend adjacent the sides of the containers C. As the inner side panels are folded with respect to the central panel 107, the bottom flaps 127, 131 can be folded outwardly to be generally perpendicular to the inner side panels 109, 113 so that the bottom tabs 135, 139 extend inwardly. Additionally, the end panels 143 can be downwardly folded as the inner side panels are downwardly folded. As the end panels 143 are downwardly folded, the gusset panels 147, 149 can be folded into face-to-face contact with the respective inner side panels 109, 113, and the end panels 143 can be disposed generally perpendicular to the inner side panels 109, 113 and the central panel 107. As shown in FIGS. 7A-7D, the bottom tabs 135, 139 can be positioned under the containers C, and the inner side panels 109, 113 and the end panels 143 can be positioned against the sides of the containers C. Accordingly, in the illustrated embodiment, the insert 12 can fit tightly around the containers, retaining the containers in the 3×4 arrangement between the inner side panels 109, 113, the end panels 143, the central panel 107, and the bottom tabs 135, 139. In one embodiment, during or after formation of the insert 12, the spacer flap 125 can be folded along the lateral fold line 111 outwardly from the central panel 107 so that the spacer flap is generally planar with the central panel 107. The erected insert 12 with the containers C is shown in FIGS. 7A-7D. The insert 12 could be otherwise formed without departing from the disclosure. For example, in an alternative embodiment, the bottom flaps 127, 131 could be folded inwardly and positioned under the containers C instead of the bottom tabs 135, 139, and the bottom tabs 135, 139 would extend outwardly with respect the inner side panels 109, 113 from the respective bottom flaps 127, 131.

As shown in FIG. 8, the insert 12 and containers C can be loaded into the interior 162 of the open-ended sleeve 160 via one of the ends 7, 9. In the illustrated embodiment, the central panel 107 is in face-to-face contact with the top wall 30 (e.g., with the second top panel 29) and the bottom flaps 127, 131 are in face-to-face contact with the bottom panel 21 as the insert 12 is inserted into the sleeve. In one embodiment, the insert 12 is pushed into the sleeve until the window 117 is generally aligned with the window 53, the dispenser opening 119 is generally aligned with the dispenser panel 82, and the opening 120 is generally aligned with the opening 91. The open-ended sleeve 160 with the loaded insert 12 is shown in FIG. 8B with the containers C omitted for clarity. As shown in FIG. 8B, the inner side panels 109, 113 are spaced apart by the respective outer side panels 17, 25 by the respective distances D1, D2. In the illustrated embodiment, the central panel 107 and the upper portions of the inner side panels 109, 113 can be at least partially retained in position, spaced apart from the outer side panels 17, 25 by the distances D1, D2, by the respective spacer projection 123 and spacer flap 125. Similarly, the lower portions of the inner side panels 109, 113 can be at least partially retained in position, spaced apart from the outer side panels 17, 25 by the distances D1, D2, by the bottom flaps 127, 131. In one embodiment, the bottom tabs 135, 139 can help retain the bottom flaps 127, 131 in face-to-face contact with the bottom panel 21 since the bottom tabs 135, 139 are disposed between the bottom panel 21 and the bottoms of the containers C. For one or both of the bottom flaps 127, 131 to pivot along respective fold lines 129, 133, the respective bottom tabs 135, 139 would need to pivot in a respectfully opposite direction (e.g., because of the stiffness of the insert material). If the bottom flaps 127, 131 were able to pivot with respect to the inner side panels 109, 113 and/or the outer side panels 17, 25, the inner side panels 109, 113 would be able to pivot outward toward the outer side panels 17, 25 (e.g., due to shifting of the inner side panels 109, 113). However, the bottom tabs 135, 139 are retained between the bottom panel 21 and the bottoms of the containers C, and the bottom tabs 135, 139 generally are restrained from pivoting. Accordingly, the bottom flaps 127, 131 also generally are restrained from pivoting. Since the bottom flaps 127, 131 are generally prevented from pivoting with respect to the inner side panels 109, 113, the bottom flaps 127, 131 abut and extend perpendicular to the outer side panels 17, 25 and retain the inner side walls 103, 113 at the distances D1, D2 from the outer side panels 17, 25. The insert 12 and the containers C could be otherwise loaded into the open-ended sleeve 160 without departing from the disclosure.

In one embodiment, the ends 7, 9 of the carton 5 can be closed as shown in FIG. 8C-9B. The side end flaps 37, 45 and the bottom end flap 41 can be inwardly folded and overlapped at the first end 7. In one embodiment, the side end flaps 37, 45 can be disposed adjacent or abut the end edges of the inner side panels 109, 113 so that the side end flap 37, 45 generally are spaced apart from the end panel 143 and the containers C by the distance D3. In the exemplary embodiment, the top end flap 33 and the reinforcing end flap 109 can be downwardly folded and overlap the side end flaps 37, 45 and the bottom end flap 41 to further at least partially close the first end 7. In one embodiment, the overlapped end flaps can be glued to one another. In the illustrated embodiment, the second end 9 can be closed in a similar or identical manner as the first end 7. The first end 7 and/or the second end 9 could be closed by other steps without departing from the disclosure.

The erected carton 5 with insert 12 and containers C is shown in FIGS. 9A-9C. In the illustrated embodiment, the carton 5 can display the contents (e.g., the containers C) through the aligned windows 53, 117. In one example, the carton 5 could be a gift box. Alternatively, the carton 5 could be any suitable carton. As shown in FIG. 9C, the containers C can be viewed through the windows 53, 117. As shown in FIG. 9C, the window 117 in the inner side panel 109 generally is larger than the window 53 in the outer side panel 17 so that the inner side panel 109 is not generally visible through the window 53. As shown in FIGS. 9A-9C, the outer carton 5 has a larger volume than the total of the containers C and generally looks bigger than the size of the containers C secured within the insert 12, spaced apart from the outer side panels 17, 25 and the ends 7, 9 of the carton. The carton 5, the insert 12, and/or the containers C could be otherwise shaped, arranged, and/or configured without departing from the disclosure.

In the illustrated embodiment, the handle 11 can be actuated as shown in FIG. 11. For example, the overlapped handle panels 57, 67 can be grasped at the handle openings 66, folding the handle flaps 63 under the handle panels and lifting the handle panels upwardly from the top wall 30. Alternatively, the handle flaps 63 could be folded upwardly with respect to the handle panels. The first handle panel 57 can separate from the first top panel 15 along the tear lines 59, 61 to at least partially form a handle opening 60 in the first top panel 15, and the second handle panel 67 can at least partially separate from the second top panel 29 and the top end flaps 49, 51. Accordingly, the second handle panel 67 can be at least partially pulled through the opening in the first top panel 15 formed from the first handle panel 57. When the carton 5 is lifted at the handle 11, the second handle panel 67 can carry the force to the ends 7, 9 of the carton 5. The handle 11 could be otherwise actuated and/or the carton 5 could be otherwise carried without departing from the disclosure.

As shown in FIGS. 10 and 11, the carton 5 can be opened at the dispenser 10 to provide access to the containers C. For example, the dispenser panel 82 can be actuated by lifting the access flap 83 and pulling the dispenser panel 82 outwardly along the fold line 97, separating the dispenser portions 81, 99 from the top panels 15, 29 and the side panel 25 along the cut lines 79, 94 and the tear lines 95. Accordingly, the dispenser panel 82 can form a dispenser opening 164 in the top wall 30 and the outer side panel 25 that is aligned with the dispenser opening 119 in the inner side panel 113. One or more of the containers C can be removed from the carton 5 and insert 12 through the dispenser openings 119, 164 (e.g., as shown in FIG. 11). As shown in FIG. 12, the dispenser 10 can be closed by folding the dispenser panel 82 over the dispenser opening 164 and inserting the locking tab 89 into the opening 91 in the second top panel 29. In one embodiment, the locking tab 89 can extend into the opening 120 in the central panel 107. The access flap 83 can be folded against the second top panel 29 to further help secure and/or retain the dispenser panel 82 in the closed position. The dispenser 10 could be otherwise actuated and/or closed without departing from the disclosure. Further, the containers C could be otherwise accessed and/or removed from the carton 5 and/or the insert 12 without departing from the disclosure.

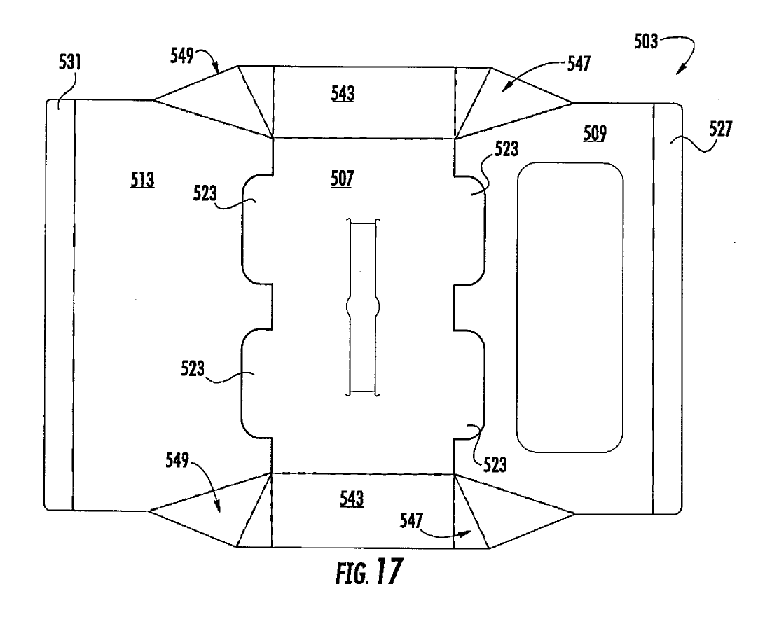

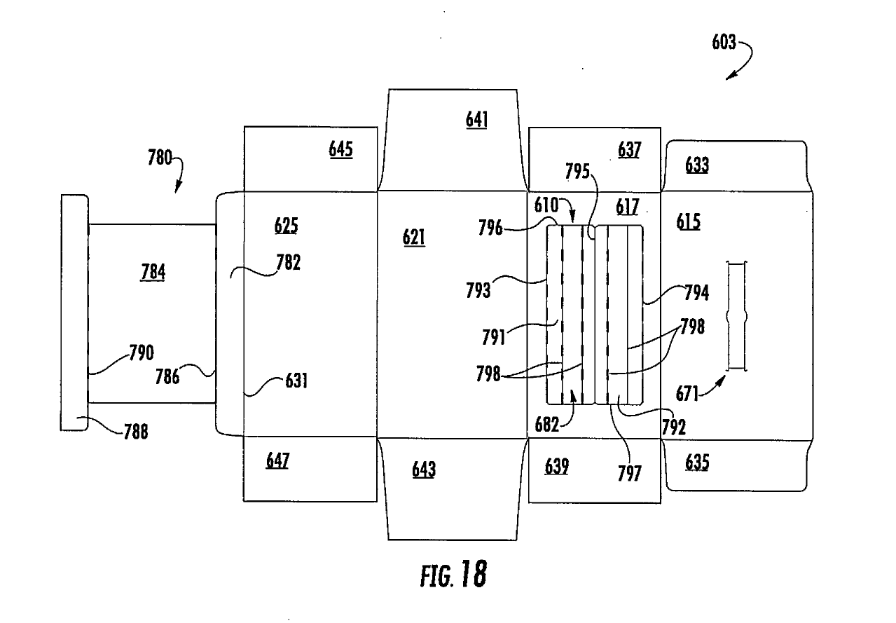

FIG. 13 is a plan view of an insert blank 303 for forming an insert 212 (FIGS. 14 and 15) according to the second embodiment of the disclosure. In one embodiment, the insert 212 can cooperate with a carton 205 (e.g., as shown in FIG. 16). The second embodiment is generally similar to the first embodiment, except for variations noted and variations that will be apparent to one of ordinary skill in the art. Accordingly, similar or identical features of the embodiments have been given like or similar reference numbers. As shown in FIG. 13, the side panel 313 includes a triangular secondary opening 319 instead of the dispenser opening 119 of the first embodiment. Alternatively, the secondary opening 319 could be omitted or could be otherwise shaped, arranged, and/or configured without departing from the disclosure. Additionally, the insert blank 303 can include outer end flaps 370 foldably connected to the bottom flaps 327, 331 along respective lateral fold lines 372. In one embodiment, when the carton 205 and the insert 212 are formed, the outer end flaps 370 can be disposed in face-to-face contact with the outer side panels of the carton 205. Further, the end panels 343 of the insert blank 303 can be wider than the end panels 143 of the first embodiment so that the end panels 343 project beyond the longitudinally-extending edges of the side panels 309, 313. In addition, as shown in FIG. 13, the insert blank 303 does not include a spacer tab or a spacer flap in the central panel 307. The insert blank 303, the insert 212, and/or the carton 205 could be otherwise shaped, arranged, and/or configured without departing from the disclosure.

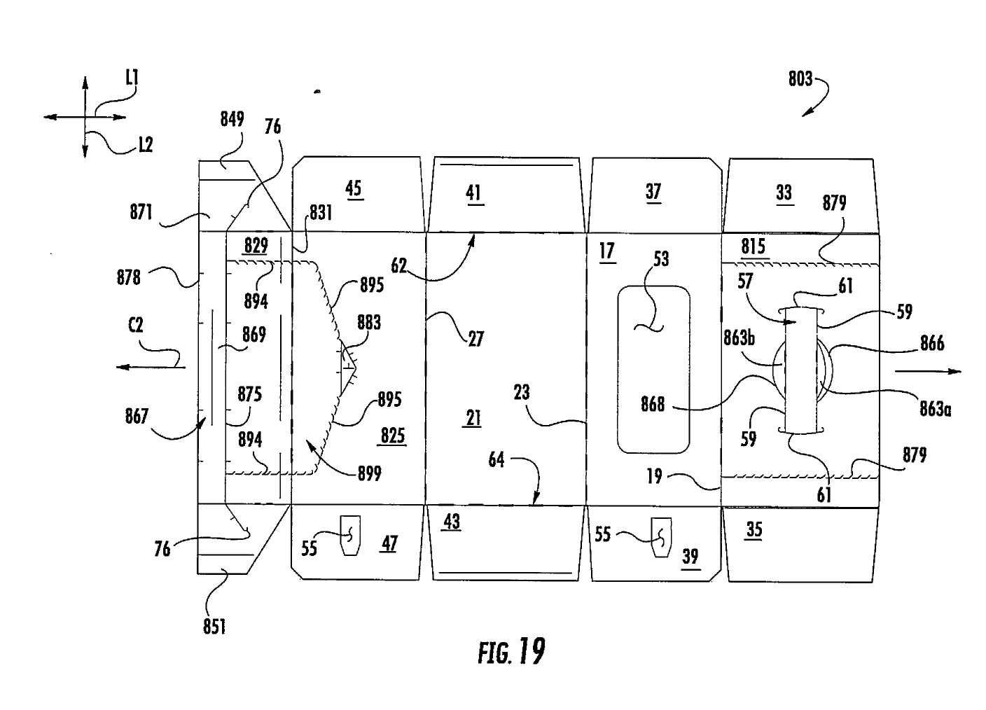

FIG. 17 is a plan view of an insert blank 503 for forming an insert (not shown) according to a third embodiment of the disclosure. The reinforcing insert of the third embodiment is generally similar to the reinforcing insert of the first embodiment, except for variations noted and variations that will be apparent to one of ordinary skill in the art. Accordingly, similar or identical features of the embodiments have been given like or similar reference numbers. As shown in FIG. 17, the insert blank 503 includes four spacer tabs 523 extending from the central panel 507. Additionally, the insert blank 503 includes two foldably-connected gusset panels 547, 549 at each corner of the central panel 507 instead of the single gusset panels of the first embodiment. Further, the central panel 507 includes a handle opening in one embodiment. As shown in FIG. 17, the bottom flaps 527, 531 do not include the bottom tabs 135, 139 of the first embodiment. In one embodiment, the inner side panel 513 lacks a dispenser opening or other opening. The insert blank 503 could be otherwise shaped, arranged, and/or configured without departing from the disclosure.

FIG. 18 is a plan view of a blank 603 for forming a carton (not shown) with a spacer feature according to a fourth embodiment of the disclosure. The blank of the fourth embodiment is generally similar to the carton blank of the first embodiment, except for variations noted and variations that will be apparent to one of ordinary skill in the art. Accordingly, similar or identical features of the embodiments have been given like or similar reference numbers. As shown in FIG. 18, the blank 603 lacks a second top panel and includes a spacer section 780 foldably connected to the second side panel 625. The spacer section 780 can include a first panel 782 that is foldably connected to the second side panel 625 along a lateral fold line 631, a second panel 784 foldably connected to the first panel 782 along a lateral fold line 786, and a bottom flap 788 foldably connected to the second panel 784 along a lateral fold line 790. In one embodiment, when the carton (not shown) is formed, the first panel 782 can be disposed in face-to-face contact with the top panel 615. In one embodiment, the first panel 782 can be glued to the top panel 615. The second panel 784 can extend downwardly from the first panel 782 and the top panel 615, generally parallel to and spaced apart from the second side panel 625. In one embodiment, the second panel 784 can be spaced apart from the second side panel 625 by the width of the first panel 782. The bottom flap 788 can be disposed in face-to-face contact with the bottom panel 621. In one embodiment, the bottom flap 788 can be glued to the bottom panel 621. Accordingly, the spacer section 780 can retain at least a portion of the containers (e.g., containers C) in the carton (not shown) between the second panel 784 and the first side panel 617 so that the containers are spaced apart from the second side panel 625. In an alternative embodiment, the second panel 784 could be positioned to be oblique with respect to the top panel 615 and/or the side panels 617, 625.

As shown in FIG. 18, the dispenser 610 extends in the first side panel 617 and includes two dispenser flaps 791, 792 foldably connected to the first side panel 617 along respective lateral fold lines 793, 794. The dispenser flaps 791, 792 can be separable from one another along a lateral cut or tear line 795 and can be separable from the first side panel 617 along respective longitudinal cut or tear lines 796, 797. Each of the dispenser flaps 791, 792 can include two intermediate fold lines 798 to help fold the dispenser flap away from the dispenser opening (not shown) formed by actuating the dispenser 10. Alternatively, the intermediate fold lines 798 could be omitted, or the dispenser flaps 791, 792 could include any suitable number of intermediate fold lines. The blank 603, the spacer section 780, and/or the dispenser 610 could be otherwise shaped, arranged, and/or configured without departing from the disclosure.

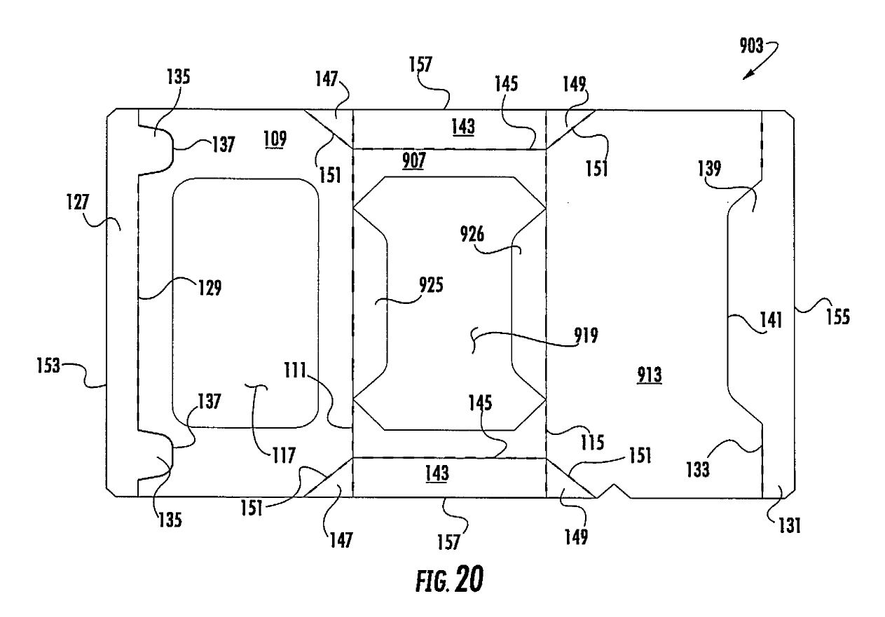

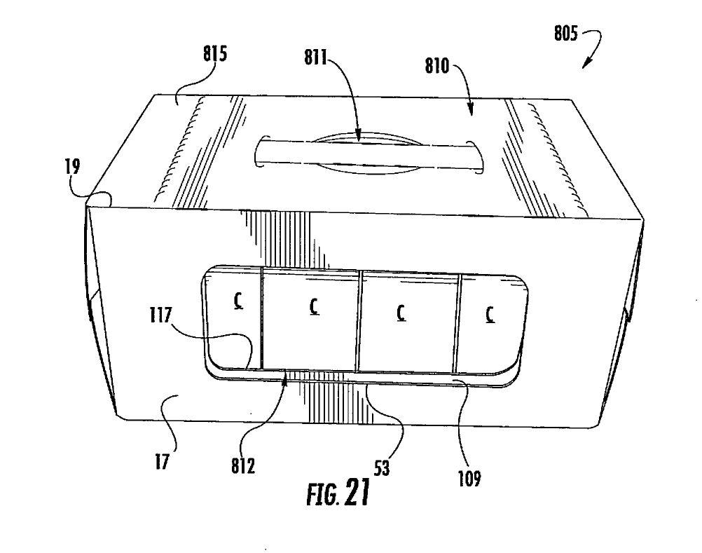

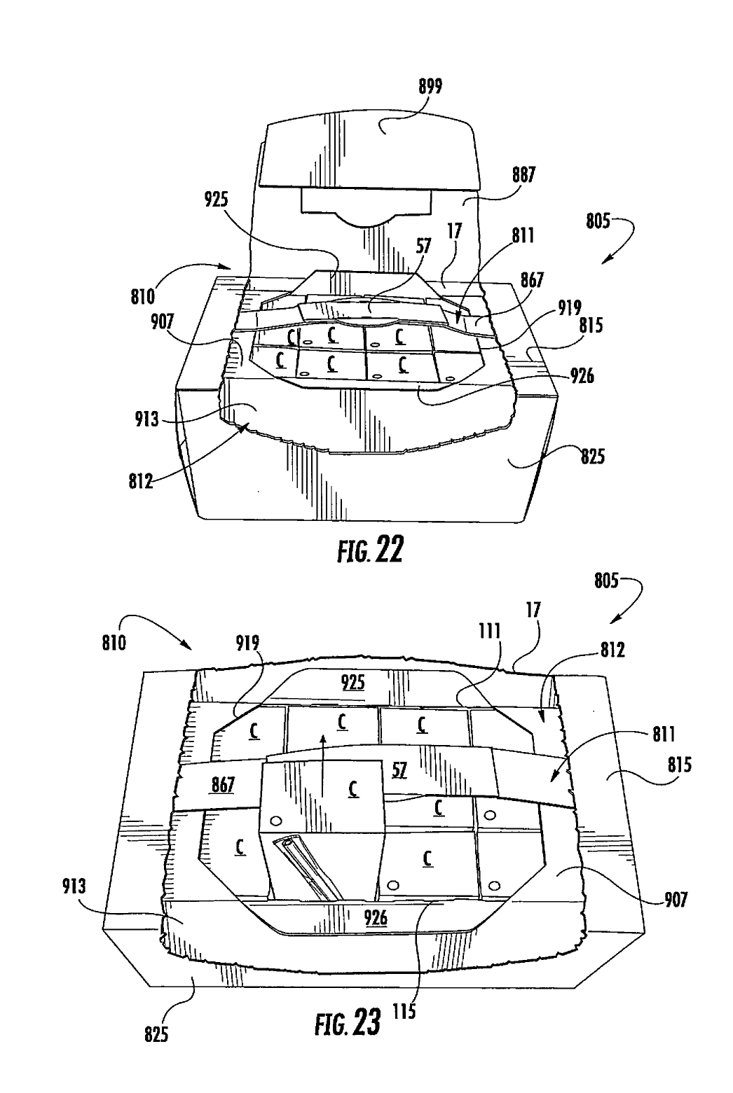

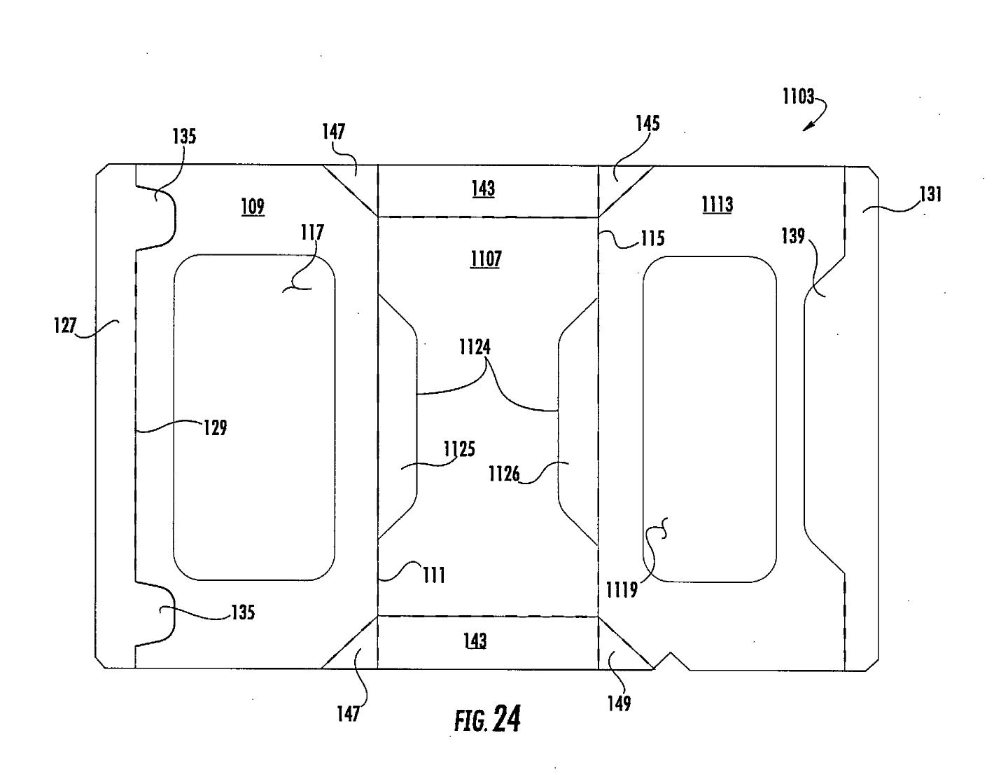

FIG. 19 is a plan view of an exterior surface 801 of a carton blank 803 for forming a carton 805 (FIGS. 21-23) according to a fifth embodiment of the disclosure. FIG. 20 is a plan view of an exterior surface 901 of an insert blank 903 for forming a reinforcing insert 812 (FIGS. 22 and 23) in the carton 805 according to the fifth embodiment of the disclosure. The fifth embodiment is generally similar to the first embodiment, except for variations noted and variations that will be apparent to one of ordinary skill in the art. Accordingly, similar or identical features of the embodiments have been given like or similar reference numbers. As shown in FIG. 19, the first top panel 815 of the carton blank 803 includes the first handle panel 57 and a handle flap 863a and a larger handle flap 863b foldably connected to the first handle panel 57 along respective fold lines 65. An access opening 866 is formed in the first top panel 815 adjacent the handle flap 863a. In the fifth embodiment, the first top panel 815 lacks an opening adjacent the larger handle flap 863b, and the handle flap 863b is separable from the first top panel along an arcuate cut line 868. The first top panel 815 and/or the handle features could be otherwise shaped, arranged, and/or configured without departing from the disclosure.

As shown in FIG. 19, the second top panel 829 and the top end flaps 849, 851 are narrower than the second top panel 29 and the top end flaps 49, 51 in the first embodiment. Accordingly, the second handle panel 867 is defined by the cut line 875 extending in the second top panel 829 and into the top end flaps 849, 851 and a laterally-extending free edge 878 of the second top panel 829 and the top end flaps 849, 851. The second top panel 829, the top end flaps 849, 851, and/or the handle features could be otherwise shaped, arranged, and/or configured without departing from the disclosure.

In the fifth embodiment, the dispenser can include a first dispenser portion 881 in the first top panel 815 and a second dispenser portion 899 in the second side panel 825 and the second top panel 829. As shown in FIG. 19, the first dispenser portion 881 is defined by two longitudinal tear lines 879. In the illustrated embodiment, the first dispenser portion 881 surrounds the first handle panel 57. In the fifth embodiment, the second dispenser portion 899 includes oblique tear lines 895 extending from an access feature 883 in the second side panel 825 and longitudinal tear lines 894 extending from the oblique tear lines 895 to the second handle panel 867 in the second top panel 829. The dispenser features could be otherwise shaped, arranged, and/or configured without departing from the disclosure.

As shown in FIG. 20, the dispenser opening 919 in the insert blank 903 is disposed in the central panel 907 in contrast to the dispenser opening 119 of the first embodiment (FIG. 2), which is disposed in the second inner side panel 113. Additionally, the spacer projection 123 of FIG. 2 in the first embodiment is replaced by a second space flap 926, which is generally aligned with the first spacer flap 925, as shown in FIG. 20. Accordingly, the spacer flaps 925, 926 are foldably connected to the respective inner side panels 109, 913 along respective lateral fold lines 111, 115 adjacent the dispenser opening 919. The dispenser opening 919 and/or the spacer flaps 925, 926 could be otherwise shaped, arranged, and/or configured without departing from the disclosure.

The carton 805, including the insert 812, is shown in FIG. 21 with containers C. In the fifth embodiment, the insert 812 is formed similarly to the insert 12 of the first embodiment, except that both of the spacer flaps 925, 926 are folded outwardly from the dispenser opening 919 (e.g., FIGS. 22 and 23). In one embodiment, when the carton 805 is formed, the first top panel 815 overlaps the second top panel 829, and the first dispenser portion 881 can be glued to the second dispenser portion 899. Additionally, the first handle panel 57 can be glued to the second handle panel 867 as shown in FIGS. 22 and 23. In one embodiment, the handle 811 can be actuated similarly to the handle 11 of the first embodiment.

In one embodiment, the dispenser 810 can be actuated by tearing along the tear lines 895, 894, and 879 from the access flap 883 in the second side panel 825, pivoting the overlapped and glued dispenser portions 881, 889 upwardly along the lateral fold line 19. In one embodiment, at least a portion of the lateral fold line 19 could be replaced by a tear or cut line so that the dispenser panel can be fully removed. As shown in FIGS. 22 and 23, when the dispenser portions 881, 899 are pivoted upwardly and/or removed from the carton 805, the containers C can be accessed through the dispenser opening 919 in the central panel 907 of the insert 812. As shown in FIGS. 22 and 23, the handle panels 57, 867 are not glued to the dispenser portions 881, 889 and are not removed from the carton 805 with the dispenser portions. Accordingly, the carton can still be carried at the handle 811 after the dispenser 810 has been actuated. The carton 805 and/or the insert 812 could be otherwise formed and/or loaded without departing from the disclosure.

FIG. 24 is a plan view of an insert blank 1103 for forming an insert (not shown) according to a sixth embodiment of the disclosure. The reinforcing insert of the sixth embodiment is generally similar to the reinforcing inserts of the first and fifth embodiments, except for variations noted and variations that will be apparent to one of ordinary skill in the art. Accordingly, similar or identical features of the embodiments have been given like or similar reference numbers. As shown in FIG. 24, the insert blank 1103 includes two spacer flaps 1125, 1126 in the central panel 1107. The spacer flaps 1125, 1126 can be defined by respective cut or tear lines 1124 in the central panel 1107 and can be foldably connected to the respective inner side panels 109, 1113 along the respective lateral fold lines 111, 115. The dispenser opening 1119 is disposed in the second inner side panel 1113 as shown in FIG. 24. Alternatively, the opening 1119 could be a secondary display opening similar to the opening 117 or a different suitable opening. Further, the opening 1119 could be omitted. The insert blank 1103 could be otherwise shaped, arranged, and/or configured without departing from the disclosure.

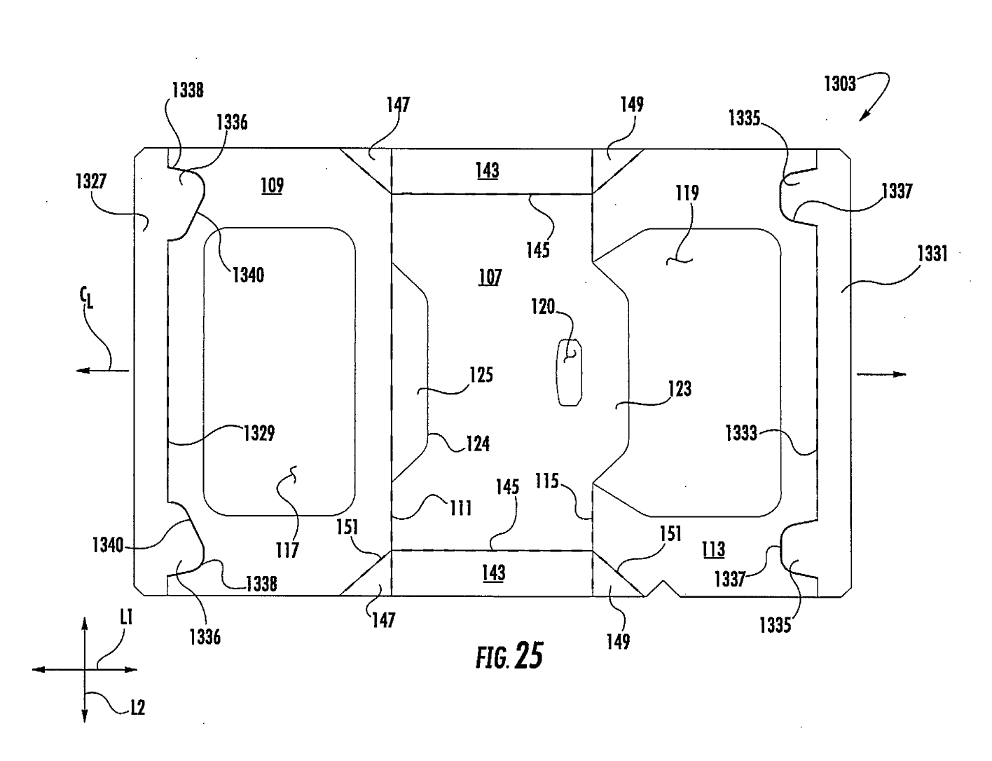

FIG. 25 is a plan view of an insert blank 1303 for forming an insert 1212 (FIGS. 27-29) according to a seventh embodiment of the disclosure. In one embodiment, the insert 1212 can cooperate with a carton such as the carton 5 (FIGS. 9A-9C), the carton 205 (FIG. 16), and/or any other suitable carton. The seventh embodiment is generally similar to the first embodiment, except for variations noted and variations that will be apparent to one of ordinary skill in the art. Accordingly, similar or identical features of the embodiments have been given like or similar reference numbers. As shown in FIG. 25, the first bottom flap 1327 is foldably connected to the first inner side panel 109, which includes the window 117, along fold line 1329. Two elongated bottom tabs 1336 can extend from the first bottom flap 1327, interrupting the fold line 1329. The elongated bottom tabs 1336 can be separable from the first inner side panel 109 along tear or cut lines 1338 and can be longer in the lateral direction L2 than the bottom tabs 135 of the first embodiment so that the elongated bottom tabs 1336 extend farther toward the longitudinal centerline CL of the blank 1303. As shown in FIG. 25, the elongated bottom tabs 1336 include an oblique or sloped portion 1340 proximate the lower edge of the window 117; however, the elongated bottom tabs 1336 could have any suitable shape without departing from the disclosure. As shown in FIG. 25, the second bottom flap 1331 includes two bottom tabs 1335, which are substantially the same as the bottom tabs 135 extending from the first bottom flap 127 in the first embodiment (FIG. 2). The bottom tabs 1335 can interrupt the fold line 1333 connecting the second bottom flap 1331 to the second inner side panel 113 and can be separable from the second inner side panel 113 along tear or cut lines 1337. The blank 1303 could be otherwise shaped, arranged, and/or configured without departing from the disclosure. For example, one or more of the bottom tabs 1335, 1336 could be replaced by a bottom tab 139 (FIG. 2), the blank 1303 could include only elongated bottom tabs 1336 or only bottom tabs 1335, and/or the blank 1303 could include any suitable number of bottom tabs 1335, 1336.

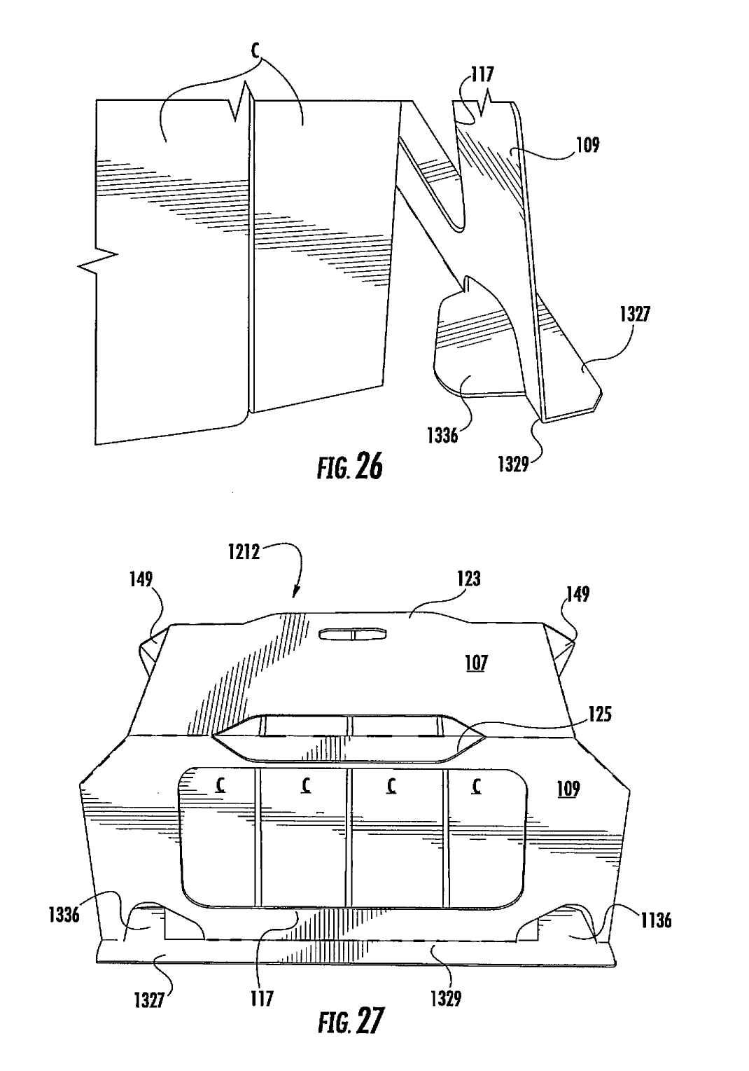

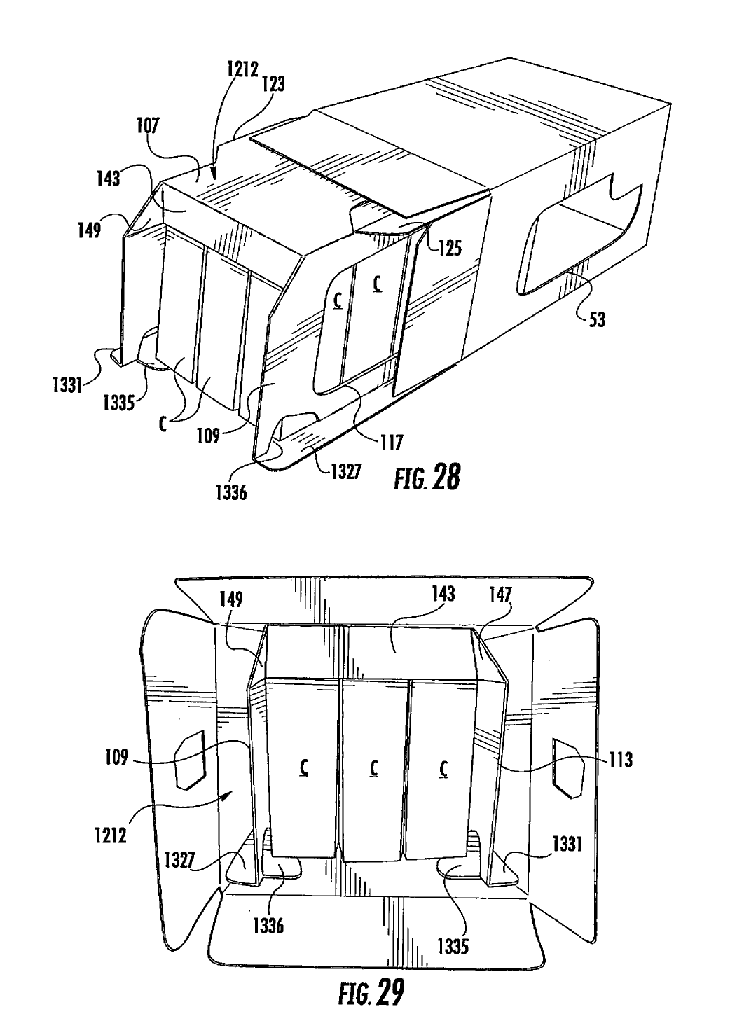

As shown in FIG. 26, the insert 1212 can be formed from the blank 1303 by wrapping the blank 1303 around containers C in a 3×4 arrangement similarly to the blank 103 in the first embodiment. In the illustrated embodiment, the elongated bottom tabs 1336 are folded inwardly with respect to the first inner side panel 109 when the first bottom flap 1327 is folded outwardly along the fold line 1329. When the first inner side panel 109 is disposed against the adjacent containers C, the elongated bottom tabs 1336 are disposed under (e.g., against a bottom surface of) adjacent containers C (FIG. 27). As shown in FIGS. 28 and 29, the insert 1212 and the containers C can be loaded into the outer carton by inserting the insert and containers through an open end of the carton. In the illustrated embodiment, the window 117 in the insert 1212 is generally aligned with a window 53 in the outer carton so that the containers adjacent the first inner side panel 109 are visible through the windows 53, 117. The insert 1212, the containers C, and/or the outer carton could be otherwise shaped, arranged, and/or configured or could be omitted without departing from the disclosure.

In the illustrated embodiment, the elongated bottom tabs 1336 can help keep the containers C adjacent the first inner side panel 109 aligned in the interior of the insert 1212. For example, in certain cases, the carton can be jostled or can be oriented with an end facing down, which can result in movement of the containers C. Such movement is limited at the top of the containers C by the end panels 143 of the insert 1212, which retain the tops of the containers. However, the bottoms of the containers C may shift within the insert 1212. For example the bottoms of the containers C might shift relative to the tops of the containers so that the containers are slanted in the insert instead of being vertically aligned with the insert. The containers C in the middle of the insert 1212 and adjacent the second inner side panel 113 generally are not visible from the exterior of the outer carton, and shifting of these containers would not be visible through the outer carton. The containers C adjacent the first inner side panel 109 are visible through the windows 53, 117 and it may be desirable to avoid and/or correct shifting of these containers. It is possible in some circumstances that a containers C disposed on one of the bottom tabs 135 of the first embodiment could shift so that the bottom of the container slides off the bottom tab 135 towards the interior of the insert. In this case it is possible that the container C could catch on the inner edge of the bottom tab 135, which could prevent the containers C adjacent the first inner side panel 109 from returning to a vertical orientation. The elongated bottom tabs 1336 extend farther toward the centerline CL of the blank 1303 so that it is less likely and/or impossible for the containers C on the elongated bottom tabs 1336 to slide off the elongated bottom tabs even if the containers shift in the insert 1212. Accordingly, if the bottoms of the containers shift, the containers can be more easily returned to a vertical orientation.

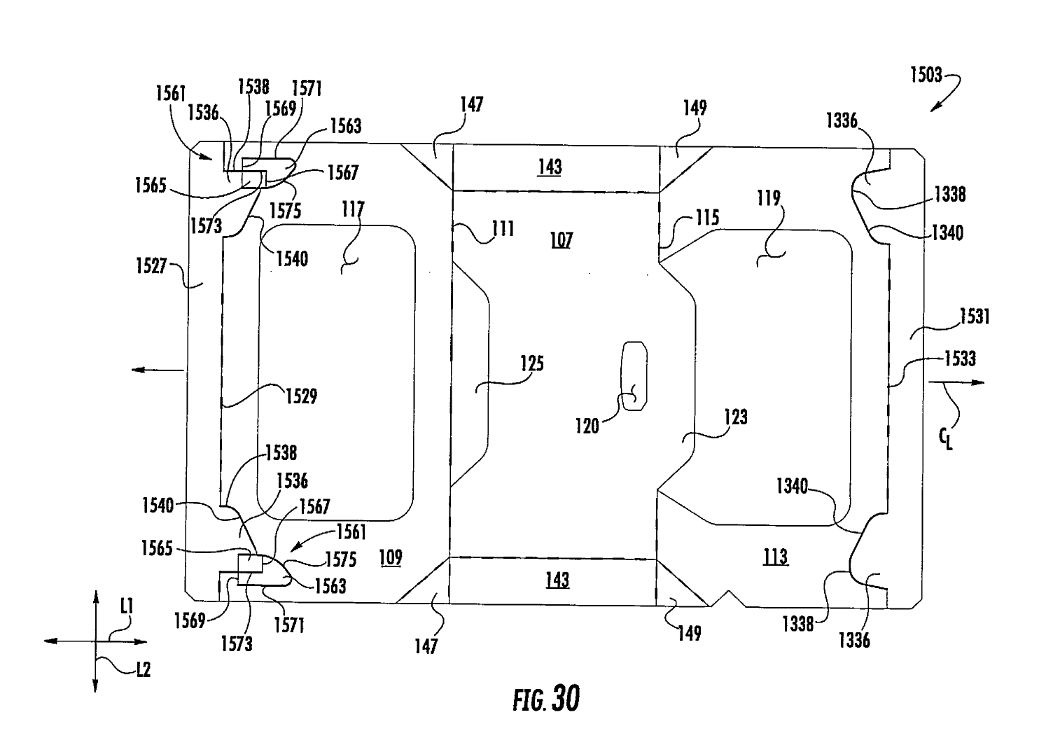

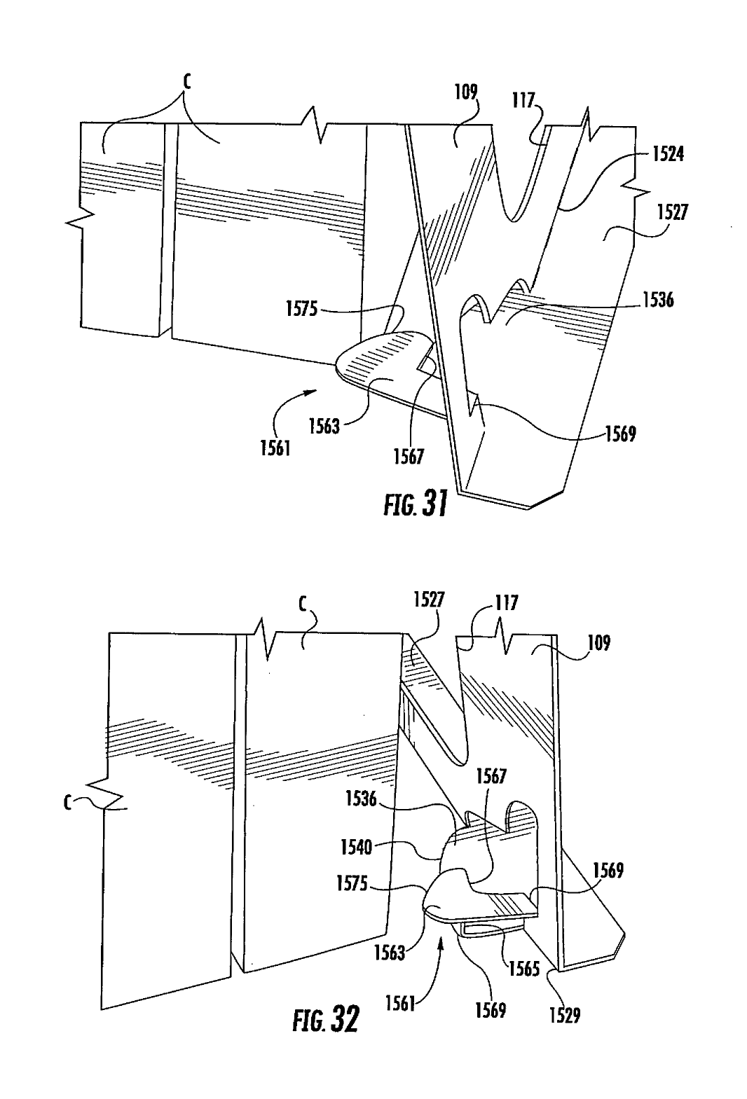

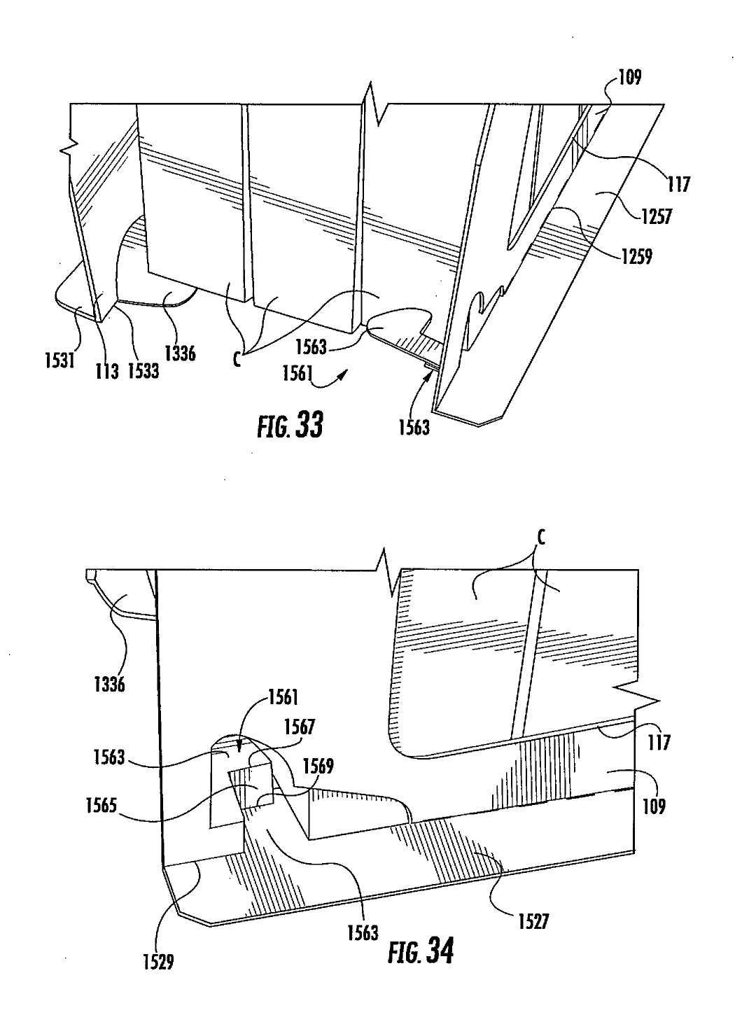

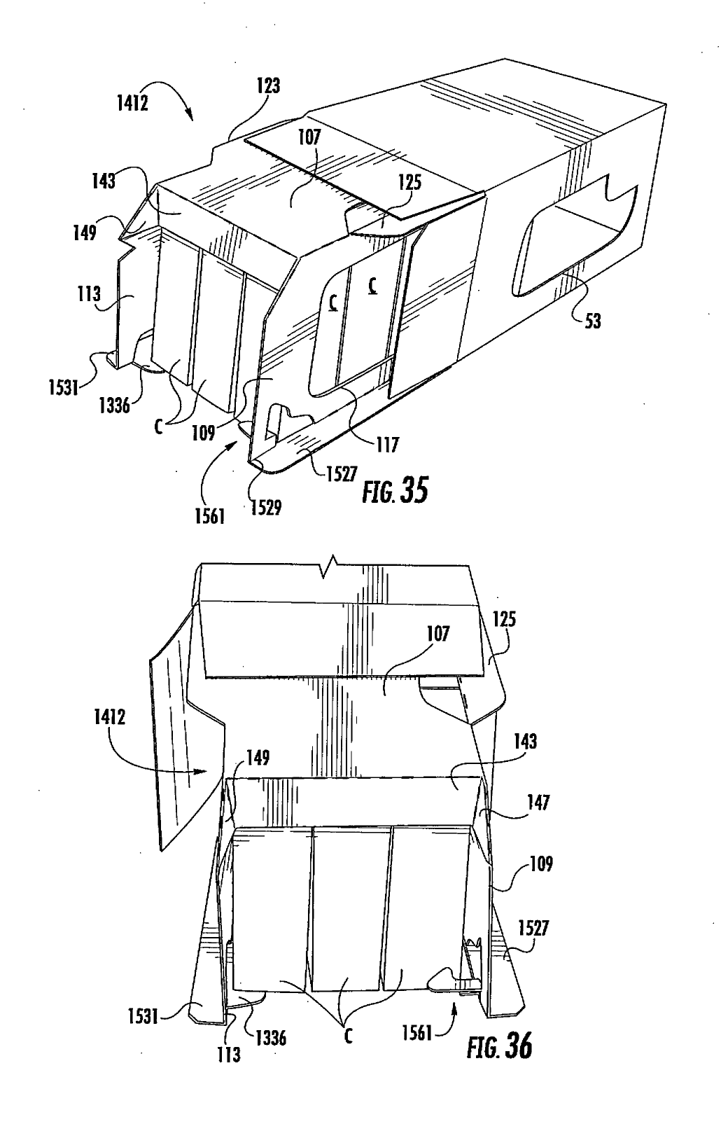

FIG. 30 is a plan view of an insert blank 1503 for forming an insert 1412 (FIGS. 33-36) according to an eighth embodiment of the disclosure. In one embodiment, the insert 1412 can cooperate with a carton such as the carton 5 (FIGS. 9A-9C), the carton 205 (FIG. 16), and/or any other suitable carton. The eighth embodiment is generally similar to the seventh embodiment, except for variations noted and variations that will be apparent to one of ordinary skill in the art. Accordingly, similar or identical features of the embodiments have been given like or similar reference numbers. As shown in FIG. 30, the first bottom flap 1527 is foldably connected to the first inner side panel 109, which includes the window 117, along fold line 1529. Two elongated bottom tabs 1536 can extend from the first bottom flap 1527 and can be separable from the first inner side panel 109 along tear or cut lines 1538 with sloped portions 1540. In the illustrated embodiment, a retaining feature 1561 can be associated with each of the elongated bottom tabs 1536. Each of the retaining features 1561 can include a main panel or cross panel 1563 (e.g., a first retention panel) foldably connected to a linking panel 1565 (e.g., a second retention panel) along a lateral fold line 1567. The cross panels 1563 and the linking panels 1565 can be respectively foldably connected to the first inner side panel 109 and the respective elongated bottom tab 1536 along a lateral fold line 1569. The cross panel 1563 and the linking panel 1565 for each retaining feature 1561 can be separable from the first inner side panel 109 and the respective elongated bottom tab 1536 along a respective tear or cut line 1571 and from one another along a tear or cut line 1573. Each of the cross panels 1563 can include a sloped lead-in 1575 that can help guide the containers C adjacent the retention portions 1561 into position and/or can help guide the first inner side panel 109 into position as the insert 1412 is formed around an arrangement of containers C (FIGS. 31-34). Two elongated bottom tabs 1336 can extend from the second bottom flap 1531, interrupting the fold line 1533. The elongated bottom tabs 1336 can be separable from the second inner side panel 113 along tear or cut lines 1338 and can include sloped portions 1340. The blank 1503 could be otherwise shaped, arranged, and/or configured without departing from the disclosure. For example, in one alternative embodiment, the elongated bottom tabs 1336 and/or 1536 could be replaced by or could have similar shapes as the bottom tabs 135 of the first embodiment.

In the illustrated embodiment, as shown in FIGS. 31-36, the insert 1412 can be formed and assembled with the containers C and the outer carton similarly or the same as the carton 1212 of the seventh embodiment. However, when the first bottom flap 1527 is folded outwardly, the retention features 1561 are actuated so that the linking panels 1565 extend upwardly from the respective elongate bottom tabs 1536 and the cross panels 1563 extend generally parallel to the elongate bottom tabs (FIGS. 31-36). In one embodiment, the distance between the fold lines 1529 and 1569 can be generally the same as the distance between the fold lines 1567 and 1569 so that the linking panel 1565 is generally vertical and the cross panel 1563 is generally horizontal in the insert 1412. Alternatively, the retaining features could be otherwise configured. For example the linking panels 1565 and/or the cross panels 1563 could be oblique with respect to the first bottom flap 1527 and/or the first inner side panel 109 when the insert 1412 is formed. The insert 1412 and/or the carton could be otherwise formed without departing from the disclosure.

As shown in FIGS. 33-36, the retention features 1561 can retain the containers C adjacent the first inner side panel 109 and visible through the windows 117 and 53 at the bottoms of the containers while allowing the containers C to be spaced apart from the ends of the carton. Accordingly, the containers adjacent the first inner side panel 109 are retained at the tops and the bottoms of the containers at the ends of the insert 1412 by the end panels 143 and the retention features 1561, respectively, and the retention features 1561 help prevent the containers that are visible in the windows from shifting or tilting. In the illustrated embodiment, the retention features 1561 can cooperate with the end panels 143 to retain the containers C adjacent the first inner side panel 109 in a vertical orientation. In the present embodiment, the retention features 1561 can be omitted in the second inner side panel 113 to help make assembly of the insert 1412 easier.

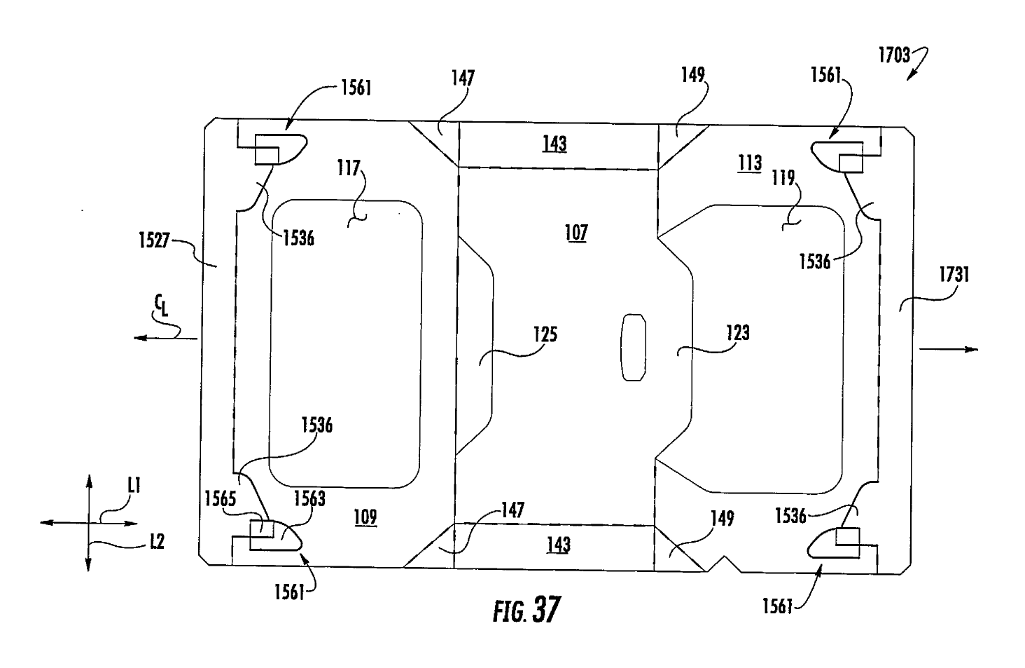

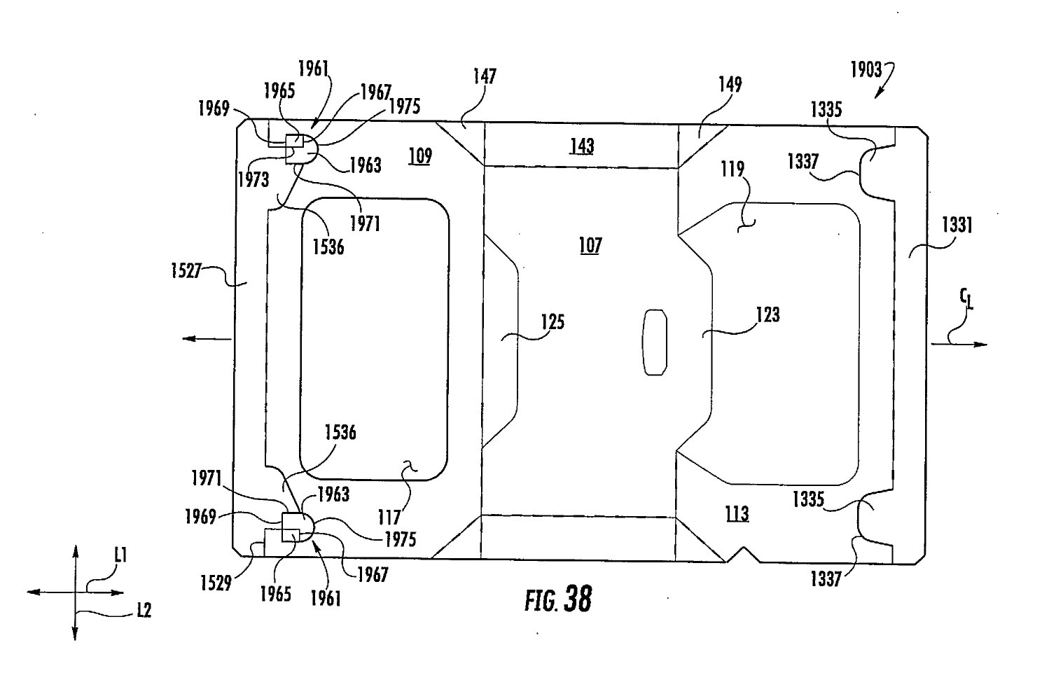

FIG. 37 is a plan view of an insert blank 1703 for forming an insert (not shown) according to a ninth embodiment of the disclosure. The ninth embodiment is generally similar to the eighth embodiment, except for variations noted and variations that will be apparent to one of ordinary skill in the art. Accordingly, similar or identical features of the embodiments have been given like or similar reference numbers. As shown in FIG. 37, the blank 1703 includes two elongate bottom tabs 1536 and retention features 1561 in the second inner side panel 113 and the second bottom flap 1731. Accordingly, the four retention features 1561 can help retain the containers C adjacent the first inner side panel 109 and the second inner side panel 113 in a vertical orientation. The blank 1703 could be otherwise shaped, arranged, and/or configured without departing from the disclosure. For example, the blank 1703 could include any suitable number of retention features 1561.

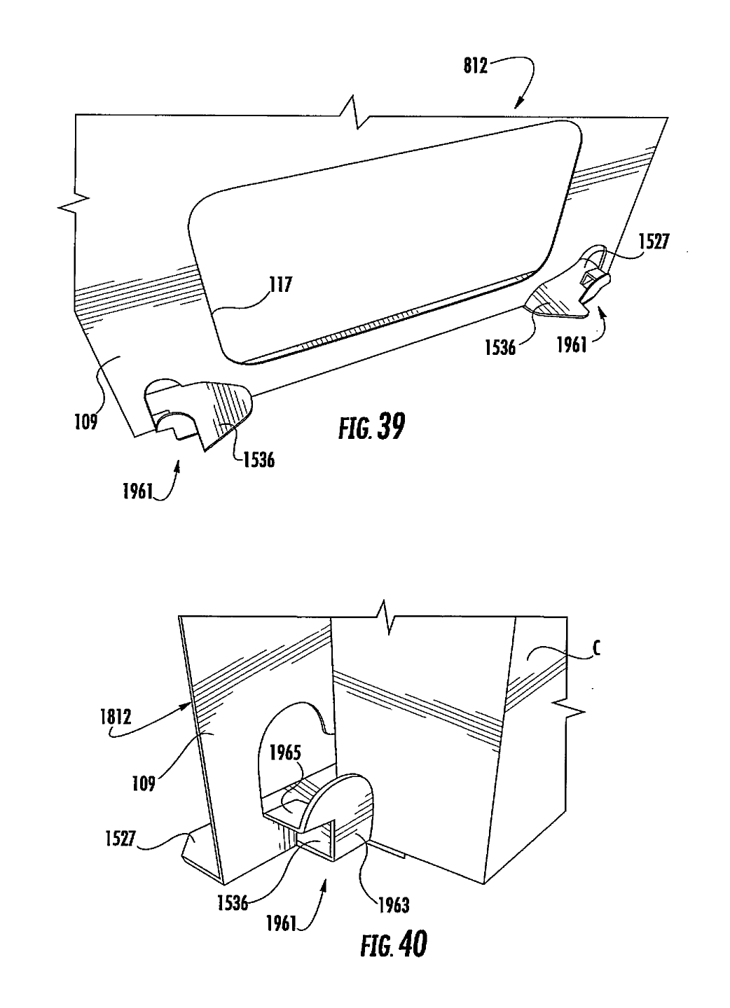

FIG. 38 is a plan view of an insert blank 1903 for forming an insert 1812 (FIGS. 39 and 40) according to a tenth embodiment of the disclosure. The tenth embodiment is generally similar to the seventh and eighth embodiments, except for variations noted and variations that will be apparent to one of ordinary skill in the art. Accordingly, similar or identical features of the embodiments have been given like or similar reference numbers. As shown in FIG. 38, each of the retention features 1961 includes a main panel 1963 (e.g., a second retention panel) foldably connected to a linking panel 1965 (e.g., a first retention panel) along a lateral fold line 1967. In the illustrated embodiment, for each of the retention features 1961, the main panel 1963 is interior to the linking panel 1965 so that the main panel 1963 engages the adjacent container C when the insert 1812 is formed (FIG. 40). The main panel 1963 and the linking panel 1965 of each retention feature 1961 are foldably connected to the respective elongated bottom tab 1536 and the first inner side panel 109 along a lateral fold line 1969. The main panels 1963 and the linking panels 1965 are separable from the first inner side panel 109 and the respective elongated bottom tab 1563 along a tear or cut line 1971 with a semicircular portion 1975. Alternatively, the cut line 1971 could have any suitable shape. The blank 1903 could be otherwise shaped, arranged, and/or configured without departing from the disclosure. For example, the blank 1903 could include any suitable number of retention features 1961.

As shown in FIGS. 39 and 40, when the insert 1812 is formed, the first bottom flap 1527 is folded outwardly, the elongated bottom tabs 1536 are folded inwardly, and the retention features 1961 are actuated so that the main panels 1963 are folded along fold lines 1969, 1967 to extend upwardly from the respective elongated bottom tab 1536. The linking panels 1965 are folded along fold lines 1967, 1969 to extend generally horizontally from the first inner side panel 109 to the respective main panel 1963. When the first inner side panel 109 is positioned against the containers C, the main panel 1963 of each retention feature 1961 engages an adjacent container C adjacent the ends of the insert (FIG. 40). The insert 1812 and/or the retention features 1961 could be otherwise formed without departing from the disclosure.

Any of the features of the various embodiments of the disclosure can be combined with, replaced by, or otherwise configured with other features of other embodiments of the disclosure without departing from the scope of this disclosure. Further, it is noted that the reinforcing inserts and insert blanks of the various embodiments can be incorporated into a carton having any carton style or panel configuration. The carton styles and panel configurations described above are included by way of example.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding a plurality of containers, the carton comprising:
a plurality of panels that extends at least partially around an interior of the carton, the plurality of panels comprising a top panel, an outer side panel, and a bottom panel; and
an insert comprising a central panel, an inner side panel foldably connected to the central panel, and a bottom flap foldably connected to the inner side panel, wherein the inner side panel is spaced apart from the outer side panel, and at least a portion of the bottom flap extends from the inner side panel to the outer side panel.

2. The carton of claim 1, wherein the insert further comprises a bottom tab extending from the bottom flap inwardly with respect to the inner side panel.

3. The carton of claim 2, wherein the bottom flap is foldably connected to the inner side panel along a fold line, and the bottom tab interrupts the fold line, an edge of the bottom tab extending from respective ends of the fold line.

4. The carton of claim 2, wherein the bottom flap and the bottom tab are at least partially in face-to-face contact with the bottom panel.

5. The carton of claim 4, wherein at least one container of the plurality of containers is for being disposed on the bottom tab.

6. The carton of claim 2, wherein the bottom tab is a first bottom tab, and the insert comprises a second bottom tab extending from the bottom flap inwardly with respect to the inner side panel.

7. The carton of claim 2, wherein:
the outer side panel is a first outer side panel, the plurality of panels further comprises a second outer side panel;
the inner side panel is a first inner side panel, the bottom flap is a first bottom flap, and the bottom tab is a first bottom tab; and
the insert comprises a second inner side panel foldably connected to the central panel, a second bottom flap foldably connected to the second inner side panel, at least a portion of the second bottom flap extending from the second inner side panel to the second outer side panel, and a second bottom tab extending from the second bottom flap inwardly with respect to the second inner side panel.

8. The carton of claim 7, wherein the insert comprises a third bottom tab extending from the first bottom panel inwardly with respect to the first inner side panel, and the third bottom tab is spaced apart from the first bottom tab.

9. The carton of claim 8, wherein the second bottom tab is an extended bottom tab that is generally centered on a centerline of the insert, and each of the first bottom tab and the second bottom tab is spaced apart from the centerline of the insert.

10. The carton of claim 8, wherein the insert comprises a fourth bottom tab extending from the second bottom panel inwardly with respect to the second inner side panel, and the fourth bottom tab is spaced apart from the second bottom tab.

11. The carton of claim 7, wherein the first bottom tab is an elongated tab extending farther toward a centerline of the insert than the second bottom tab.

12. The carton of claim 11, wherein the first inner side panel at least partially defines an inner window, the first outer side panel at least partially defines an outer window, and the inner window is at least partially aligned with the outer window for displaying at least a portion of the plurality of containers.

13. The carton of claim 11, wherein the first bottom tab comprises an oblique edge extending toward the centerline of the insert.

14. The carton of claim 7, wherein the insert further comprises a retention feature comprising a first retention panel foldably connected to the first inner side panel and a second retention panel foldably connected to the first bottom tab and the first retention panel, at least one container of the plurality of containers is for being disposed on the first bottom tab, and the retention feature is for engaging a side of the at least one container.

15. The carton of claim 2, wherein the insert further comprises a retention feature for engaging a side of at least one container of the plurality of containers.

16. The carton of claim 15, wherein the retention feature comprises a first retention panel foldably connected to the inner side panel along a first fold line and a second retention panel foldably connected to the bottom tab along a second fold line.

17. The carton of claim 16, wherein the first retention panel extends generally parallel to the bottom tab inwardly from the inner side panel, and the second retention panel extends generally upwardly from the bottom tab to the first retention panel.

18. The carton of claim 17, wherein the second retention panel is foldably connected to the first retention panel along a third fold line that is generally vertically spaced from the second fold line and generally horizontally spaced from the first fold line.

19. The carton of claim 16, wherein at least one of the first retention panel and the second retention panel comprises a sloped lead-in edge.

20. The carton of claim 1, wherein the bottom flap comprises a bottom tab extending from the bottom flap, the bottom tab is the portion of the bottom flap extending from the inner side panel to the outer side panel, and at least a portion of the bottom flap extends inwardly from the inner side panel.

21. The carton of claim 1, wherein the insert further comprises a spacer tab extending from the central panel adjacent the inner side panel and toward the outer side panel.

22. The carton of claim 1, wherein the insert further comprises a spacer flap foldably connected to the inner side panel along a fold line, and the spacer flap extends from the inner side panel adjacent the top panel to the outer side panel.

23. The carton of claim 1, further comprising a handle comprising a handle panel in at least the top panel.

24. The carton of claim 23, wherein the top panel is a first top panel, the plurality of top panels comprises a second top panel at least partially overlapping the first top panel, and the first top panel and the second top panel at least partially overlap the central panel.

25. The carton of claim 24, wherein the handle panel is a first handle panel, the handle comprises a second handle panel in the second top panel, and the second handle panel at least partially overlaps the first handle panel.

26. The carton of claim 25, wherein the first handle panel is at least partially separable from the first top panel along a first line of weakening, and the second handle panel is at least partially separable from the second top panel along a second line of weakening for at least partially forming a handle opening in the second top panel.

27. The carton of claim 25, further comprising a dispenser comprising a dispenser panel at least partially defined by a tear line in the first top panel and the second top panel, at least a portion of the dispenser panel extends in the first top panel adjacent the first handle panel, at least a portion of the dispenser panel extends in the second top panel adjacent the second handle panel, and the central panel of the insert comprises a dispenser opening that is at least partially aligned with the dispenser panel in the first top panel and the second top panel.

28. The carton of claim 23, further comprising a plurality of end flaps respectively foldably connected to respective panels of the plurality of panels, the plurality of end flaps comprising at least a top end flap foldably connected to the top panel and at least partially forming an at least partially closed end of the carton, wherein the handle panel extends at least partially into the top end flap.

29. The carton of claim 1, wherein the outer side panel comprises an outer window and the inner side panel comprises an inner window at least partially aligned with the outer window.

30. The carton of claim 29, wherein the inner window is generally larger than the outer window.

31. The carton of claim 1, further comprising a dispenser comprising a dispenser panel at least partially defined by a tear line in at least the outer side panel.

32. The carton of claim 31, wherein the insert comprises a dispenser opening extending in at least the inner side panel, the dispenser opening being generally aligned with the dispenser panel.

33. The carton of claim 31, wherein the dispenser panel and the tear line further extend in the top panel, and the dispenser further comprises a locking tab foldably connected to the dispenser panel for engaging a receiving opening in the top panel to at least partially retain the dispenser panel in a closed position.

34. The carton of claim 1, further comprising at least one end flap foldably connected to a respective panel of the plurality of panels, the at least one end flap at least partially forming an at least partially closed end of the carton, wherein the insert comprises at least one end panel connected to the inner side panel by at least one gusset, the central panel and the at least one end panel being spaced apart from the closed end of the carton.

35. The carton of claim 34, wherein the end panel is foldably connected to the central panel and extends generally downwardly from the central panel for engaging a side of at least one container of the plurality of containers.

36. The carton of claim 34, wherein an edge of the inner side panel is disposed adjacent the closed end of the carton.

37. In combination, a carton blank and an insert blank for forming a carton and an insert at least partially disposed in the carton for holding a plurality of containers:
the carton blank comprising a plurality of panels comprising a top panel, an outer side panel, and a bottom panel; and
the insert blank comprising a central panel, an inner side panel foldably connected to the central panel, and a bottom flap foldably connected to the inner side panel, wherein the inner side panel is for being spaced apart from the outer side panel and at least a portion of the bottom flap is for extending from the inner side panel to the outer side panel when the carton and the insert are formed from the carton blank and the insert blank.

38. The combination of claim 37, wherein the insert blank further comprises a bottom tab extending from the bottom flap, the bottom tab is at least partially separable from the inner side panel along a cut line, and the bottom tab is for being positioned to extend inwardly with respect to the inner side panel when the insert is formed from the insert blank.

39. The combination of claim 38, wherein the bottom flap is foldably connected to the inner side panel along a fold line, the bottom tab interrupts the fold line, and cut line comprises two ends each extending from respective ends of the fold line.

40. The combination of claim 38, wherein the bottom tab is a first bottom tab the cut line is a first cut line, the insert blank comprises a second bottom tab extending from the bottom flap, and the second bottom tab is at least partially separable from the inner side panel along a second cut line.

41. The combination of claim 38, wherein:
the outer side panel is a first outer side panel, the plurality of panels further comprises a second outer side panel;
the inner side panel is a first inner side panel, the bottom flap is a first bottom flap, the bottom tab is a first bottom tab, and the cut line is a first cut line; and
the insert blank further comprises a second inner side panel foldably connected to the central panel, a second bottom flap foldably connected to the second inner side panel, and a second bottom tab extending from the second bottom flap; and
the second bottom tab is at least partially separable from the second inner side panel along a second cut line.

42. The combination of claim 41, wherein the insert blank comprises a third bottom tab extending from the first bottom panel, and the third bottom tab is at least partially separable from the first inner side panel along a third cut line and is spaced apart from the first bottom tab.

43. The combination of claim 42, wherein the second bottom tab is an extended bottom tab that is generally centered on a centerline of the insert blank, and each of the first bottom tab and the second bottom tab is spaced apart from the centerline of the insert blank.

44. The combination of claim 42, wherein the insert blank comprises a fourth bottom tab extending from the second bottom panel, and the fourth bottom tab is at least partially separable from the second inner side panel along a fourth cut line and is spaced apart from the second bottom tab.

45. The combination of claim 41, wherein the first bottom tab is an elongated tab extending farther toward a centerline of the insert blank than the second bottom tab.

46. The combination of claim 45, wherein the first cut line of the first bottom tab comprises an oblique portion extending toward the centerline of the insert blank.

47. The combination of claim 41, wherein the insert blank further comprises a retention feature comprising a first retention panel foldably connected to the first inner side panel and a second retention panel foldably connected to the first bottom tab and the first retention panel, and the first retention panel and the second retention panel are at least partially separable from the first inner side panel and the first bottom tab along a third cut line.

48. The combination of claim 38, wherein the insert blank further comprises a retention feature for engaging a side of at least one container of the plurality of containers when the insert is formed from the insert blank.

49. The combination of claim 48, wherein the retention feature comprises a first retention panel foldably connected to the inner side panel along a first fold line and a second retention panel foldably connected to the bottom tab along a second fold line.

50. The combination of claim 49, wherein the first fold line is generally collinear with the second fold line.

51. The combination of claim 49, wherein the second retention panel is foldably connected to the first retention panel along a third fold line that is spaced apart from the second fold line and is generally parallel to the second fold line.

52. The combination of claim 51, wherein the cut line of the bottom tab is a first cut line, and the first retention panel is at least partially separable from the second retention panel along a second cut line extending from an end of the second fold line to an end of the third fold line.

53. The combination of claim 52, wherein the second cut line is generally collinear with at least a portion of the first cut line.

54. The combination of claim 49, wherein the cut line of the bottom tab is a first cut line, and the first retention panel and the second retention panel are at least partially defined by a cut line in the inner side panel and the bottom tab, the second cut line extending from respective ends of the first fold line and the second fold line.

55. The combination of claim 54, wherein the second cut line comprises an arcuate portion for forming a sloped lead-in edge of at least one of the first retention panel and the second retention panel.

56. The combination of claim 37, wherein the bottom flap comprises a bottom tab extending from the bottom flap, the bottom tab is the portion of the bottom flap that is for extending from the inner side panel to the outer side panel when the carton and the insert are formed from the carton blank and the insert blank, and at least a portion of the bottom flap is for extending inwardly from the inner side panel when the carton and the insert are formed from the carton blank and the insert blank.

57. The combination of claim 37, wherein the insert blank further comprises a spacer tab extending from the central panel, the spacer tab is at least partially separable from the inner side panel along a cut line.

58. The combination of claim 37, wherein the insert blank further comprises a spacer flap foldably connected to the inner side panel along a fold line, the spacer flap is at least partially separable from the central panel along a cut line, and the spacer flap is for being positioned to extend from the inner side panel to the outer side panel when the carton is formed from the carton blank and the insert is formed from the insert blank.

59. The combination of claim 37, wherein the insert blank further comprises a spacer flap foldably connected to the inner side panel adjacent an opening in the central panel, and the spacer flap is for being positioned to extend from the inner side panel to the outer side panel when the carton is formed from the carton blank and the insert is formed from the insert blank.

60. The combination of claim 37, further comprising a handle comprising a handle panel in at least the top panel.

61. The combination of claim 60, wherein the top panel is a first top panel, the plurality of top panels comprises a second top panel for at least partially overlapping the first top panel when the carton is formed from the carton blank.

62. The combination of claim 61, wherein the handle panel is a first handle panel, the handle comprises a second handle panel in the second top panel, and the second handle panel is for at least partially overlapping the first handle panel when the carton is formed from the carton blank.

63. The combination of claim 62, wherein the first handle panel is at least partially separable from the first top panel along a first line of weakening, and the second handle panel is at least partially separable from the second top panel along a second line of weakening.

64. The combination of claim 62, further comprising dispenser features for forming a dispenser in the carton and the insert formed from the carton blank and the insert blank, the dispenser features comprise a dispenser panel at least partially defined by a tear line in the first top panel and the second top panel, at least a portion of the dispenser panel extends in the first top panel adjacent the first handle panel, at least a portion of the dispenser panel extends in the second top panel adjacent the second handle panel, and the central panel of the insert blank comprises a dispenser opening that is for being at least partially aligned with the dispenser panel in the first top panel and the second top panel when the carton and the insert are formed from the carton blank and the insert blank.

65. The combination of claim 60, further comprising a plurality of end flaps respectively foldably connected to respective panels of the plurality of panels, the plurality of end flaps comprising at least a top end flap foldably connected to the top panel, wherein the handle panel extends at least partially into the top end flap.

66. The combination of claim 37, wherein the outer side panel comprises an outer window and the inner side panel comprises an inner window, the inner window is for being at least partially aligned with the outer window when the carton and the insert are formed from the carton blank and the insert blank.

67. The combination of claim 66, wherein the inner window is generally larger than the outer window.

68. The combination of claim 37, further comprising dispenser features for forming a dispenser in the carton and the insert formed from the carton blank and the insert blank, wherein the dispenser features comprise a dispenser panel at least partially defined by a tear line in at least the outer side panel.

69. The combination of claim 68, wherein the insert blank comprises a dispenser opening extending in at least the inner side panel, and the dispenser opening is for being generally aligned with the dispenser panel when the carton and the insert are formed from the carton blank and the insert blank.

70. The combination of claim 68, wherein the dispenser panel and the tear line further extend in the top panel, and the dispenser features further comprise a locking tab foldably connected to the dispenser panel for engaging a receiving opening in the top panel to at least partially retain the dispenser panel in a closed position when the carton is formed from the carton blank.

71. The combination of claim 37, wherein the insert blank comprises at least one end panel connected to the inner side panel by at least one gusset.

72. A method of forming a carton for holding a plurality of containers, the method comprises:
obtaining a carton blank and an insert blank, the carton blank comprising a plurality of panels comprising a top panel, an outer side panel, and a bottom panel, and the insert blank comprising a central panel, an inner side panel foldably connected to the central panel, and a bottom flap foldably connected to the inner side panel;
forming an interior of the carton at least partially defined by the plurality of panels of the carton blank, the forming the interior of the carton comprising forming an open-ended sleeve;
forming an insert from the insert blank; and
positioning the insert at least partially in the interior of the carton so that the inner side panel is spaced apart from the outer side panel, and at least a portion of the bottom flap extends from the inner side panel to the outer side panel.

73. The method of claim 72, wherein the forming the insert comprises folding the inner side panel with respect to the central panel and folding the bottom flap with respect to the inner side panel.

74. The method of claim 73, wherein the positioning the insert comprises positioning the central panel in face-to-face contact with the top panel and positioning the bottom flap in face-to-face contact with the bottom panel.

75. The method of claim 73, wherein the insert blank further comprises a bottom tab extending from the bottom flap, and the folding the bottom flap comprises separating the bottom tab from the inner side panel to extend inwardly with respect to the inner side panel.

76. The method of claim 73, wherein the bottom flap comprises a bottom tab extending from the bottom flap, the folding the bottom flap comprises folding the bottom flap inwardly with respect to the inner side panel so that the bottom tab is folded outwardly, and the positioning the insert comprises positioning the bottom flap to extend from the inner side panel to the outer side panel.

77. The method of claim 72, further comprising positioning the central panel to engage respective tops of the containers of the plurality of containers prior to the forming the insert, and the forming the insert comprises folding the inner side panel to extend along at least one side of at least one container of the plurality of containers, and folding the bottom flap away from the plurality of containers.

78. The method of claim 77, wherein the insert blank further comprises a bottom tab extending from the bottom flap, and the folding the bottom flap and the folding the inner side panel causes the bottom tab to engage a bottom of the at least one container.

79. The method of claim 78, wherein the insert blank further comprises a retention feature comprising a first retention panel foldably connected to the inner side panel and a second retention panel foldably connected to the bottom flap and the first retention panel, the folding the bottom flap causing the first retention panel to extend inwardly from the inner side panel and the second retention panel to extend generally upwardly from the bottom tab, and the folding the inner side panel causes the retention feature to engage the at least one container.

80. The method of claim 77, wherein the insert blank further comprises an end panel connected to the inner side panel by a gusset, and the forming the insert further comprises folding the end panel and the gusset with respect to the central panel and the inner side panel so that the end panel engages at least one container of the plurality of containers.

81. The method of claim 72, wherein the insert blank comprises an inner window in the inner side panel, the carton blank comprises an outer window in the outer side panel, and the positioning the insert comprises at least partially aligning the inner window with the outer window.
